(19) United States
(12) Patent Application Publication
(10) Pub. No.: US 2007/0117455 A1
(43) Pub. Date: May 24, 2007

(54) Dedviced for suspending articles or for securing a bearing means

(76) Inventor: Herbert Walter, MULLHEIM (DE)

Correspondence Address: MCCARTER & ENGLISH, LLP, FOUR GATEWAY CENTER, 100 MULBERRY STREET, NEWARK, NJ, 07102, US

(21) Appl. No.: 10/582,539

(22) PCT Filed: Nov. 9, 2004
(86) PCT No.: PCT/CH04/00679

§ 371 Date: Jun. 9, 2006

(30) Foreign Application Priority Data
Dec. 11, 2003 (DE) 203 19 266.4

(51) Int. Cl. H01R 9/05

(52) U.S. Cl. 439/581

(57) ABSTRACT

The device is based upon a plug socket (1) with a front plug opening (11) and a load support (2) which may be suspended therein. A stop contour (17) lies in the plug-in socket (1). The load support (2) has a plug-in section (25), fitting through the plug opening (11), comprising a counter-contour (26), for cooperation with the stop contour (17). The engagement of the stop contour (17) and the counter-contour (26), in a locked state, is achieved as a result of a maximum insertion of the plug-in piece (25) into the plug socket (1) and displacement of the load support (2) in entirety in the horizontal with the then horizontally-positioned plug-in section (25). The stop contour (17) is embodied as a projection on the underside of the cover (13), whilst the counter-contours (26) are recesses. A holder (5) is preferably provided for fixing the plug socket (1) which can be mounted on the rear face of a panel (4), or on a hollow vertical support. In one embodiment the device is electrified.

### FIELD OF THE INVENTION

The invention relates to a device for suspending articles or for securing a bearing means, with a plug-in sleeve, which can be inserted into a carrying structure and, in most applications, is encased in a sleeve holder, and a carrying arm, which can be engaged in the plug-in sleeve. Typical examples of carrying structures are panels, rear walls and supports. Such devices are used predominantly in shops and exhibitions for displaying goods. The articles displayed—e.g. items of clothing, accessories and packed goods—can be hung directly on the carrying arm or the carrying arm supports a bearing means, which may be, for example, in the form of a shelf, of a box or of a basket.

### PRIOR ART

For shop and trade-fair construction, a high level of variability, esthetically pleasing designs and cost-effectiveness are required of the devices used. According to EP 0 716 825 B1, plug-in sleeves are inserted individually, or in a methodically distributed manner, into a rear wall. The device comprises a plug-in sleeve and a carrying arm, which can be straightforwardly plugged into the plug-in mount and disengage therefrom. As a variant, it is possible for the plug-in sleeve to be positioned on the front side or rear side of a panel element, to be inserted into such a panel element or to be assembled on a rack element. The carrying arm has a plug-in plate and a rod part attached thereto. In the angled state, the plug-in plate can be introduced through the window-like plug-in opening into the housing and, following a slight displacement, can be arrested behind buffer edges. The rod part itself can be utilized for hanging goods or secures a goods carrier. It is also possible for a goods carrier to be seated on the rod parts of a plurality of adjacent carrying arms and/or for a plurality of rod parts to be connected by means of transverse rods. For this purpose, plug-in sleeves are arranged in a methodically distributed manner. This device continues to be successful, but is designed predominantly for square plug-in sleeves and requires a plug-in plate on the carrying arm.

The device according to WO 01/41604 A1 is based on the same principle, the plug-in opening being located in a sleeve component which is enclosed by a set-back positioning flange. In the assembled state, the positioning flange ends up located on the rear side of the carrying structure, while the sleeve component projects into an opening made in the carrying structure.

The arrangement according to WO 97/26809 A1 likewise comprises a plug-in sleeve, which is inserted directly into a rear wall or into a panel and into which a carrying rod can be plugged. The carrying rod, which is in the form of a tubular component, has a latching mechanism which is arranged in its plug-in end and has an actuable lever element with a movable catch which, in the plugged-together state, latches, for arresting purposes, into an engagement contour provided in the plug-in sleeve. In the case of the device according to WO 99/20094 A2, the carrying rod has, at the plug-in end, a hook contour which serves for fixing purposes, under the force of a leaf spring, in the plug-in sleeve. When the carrying rod is pushed in, a portion of the leaf spring which is contoured in a V-shaped manner latches into the hook contour on the carrying rod. The functioning of the device comprising a plug-in sleeve and a carrying rod according to WO 01/87123 A1 is similar. The hook contour, which is provided at the front end of the carrying rod, likewise comes into engagement with a spring element which is arranged inside the plug-in sleeve, but extends integrally from the plug-in sleeve, which is a plastic injection molding, as an elastically flexible tongue.

WO 01/43599 A1 also discloses a plug-in sleeve, which can be inserted into a carrying structure, and a carrying rod, which can be plugged into the plug-in sleeve. The plug-in sleeve has a plug-in opening which extends between a front entry and a rear boundary. At the top, the plug-in opening has a bevel, which slopes upward in the direction of the entry and thus forms a clearance at the top. At the bottom, the plug-in opening has an inclination, which slopes downward in the direction of the boundary and thus produces a clearance at the bottom. Inside, the plug-in sleeve has a top undercut and the carrying rod has a tongue which can be plugged into the plug-in opening and has an upwardly directed hook, which is intended for engaging in the undercut.

### OBJECT OF THE INVENTION

Taking the existing devices as the departure point, it is an object of the invention, while maintaining a plug-in sleeve and a load carrier which can be engaged therein, to improve, in particular, the rotational stability of the plugged-in carrying arm, which is relevant predominantly in the case of carrying arms of T-shaped configuration being subjected to a relatively high level of asymmetric loading. The inner configuration of the plug-in sleeve for fixing the plugged-in carrying arm is to be functionally reliable, so that the carrying arms are seated securely in the plug-in sleeves and appear precisely in alignment with one another. Even with a lot of activity taking place round about, the plugged-in carrying arm has to be arrested in a reliable manner, although the intention is for it to be easy to remove again with very straightforward handling.

A further object is to make it possible for the plug-in sleeve to be assembled efficiently in different types of carrying structure. The concern here is to incorporate load carriers, e.g. carrying arms, in a wide variety of different configurations, and the fifting of the load carriers with shelves, in the design, so that the interior designer has a wide range of possible variations and combinations for constructing esthetically pleasing arrangements.

A next object is to electrify the device, so that power which is channeled up via the plug-in sleeve passes, via the plugged-in load carrier, to a consuming unit, e.g. a luminaire.

The final object of the invention is to extend the range of devices of the generic type on offer. The device which is to be produced is to be capable of cost-effective mass production and assembly.

### OVERVIEW OF THE INVENTION

The device for hanging articles or for securing a bearing means is based on a plug-in sleeve and a load carrier, e.g. a carrying arm or a shelf, which can be fitted into this plug-in sleeve. The plug-in sleeve has a front plug-in opening which continues axially as a free space into the interior of the plug-in sleeve. The plug-in sleeve, which is intended for fastening directly or indirectly on a carrying structure, has an arresting contour on its inside. The load carrier has a plug-in part which is adapted for introducing into the plug-in opening and has a mating contour, which is provided for engagement with the arresting contour on the plug-in sleeve. Articles can be hung directly on the load carrier or can be placed on a bearing means supported by the load carrier.

The configuration of the plug-in part and plug-in sleeve forces the introduction of the plug-in part into the plug-in sleeve with the load carrier inclined in relation to the horizontal overall, the plug-in part being in a lowered position. The engagement between the arresting contour and the mating contour, as the locked stated, is achieved once the load carrier moves as a whole into the horizontal with the plug-in part located horizontally. The arresting contour is formed on the underside of the ceiling and/or on the side flanks of the housing of the plug-in sleeve. The mating contour is provided on the top side of the plug-in part and/or on the side flanks thereof, the arresting contour being designed as an elevation and the mating contour being designed as a recess.

Specific embodiments of the device are described hereinbelow: the arresting contour is arranged on both sides of the ceiling of the housing of the plug-in sleeve, at the transition to the side flanks of the latter, and the mating contour is located in the two side flanks of the plug-in part. The arresting contour on both sides preferably extends essentially from the ceiling and is directly adjacent to the side flanks of the housing of the plug-in sleeve. The mating contour is provided in the two side flanks of the plug-in part in each case as a recess which passes vertically all the way through and is set back in relation to the end, as a result of which an outer claw is produced in each case in the front corner regions of the plug-in part. The arresting contour on both sides begins, in the direction of the front plug-in opening, with an inlet located on the same plane as the ceiling, and slopes up in a wedge-shaped manner in the opposite direction. The arresting contour terminates, toward the rear part of the housing of the plug-in sleeve, with a buffer edge. In the locked state, the two outer claws grip behind the associated buffer edge in each case.

The plug-in opening is of rectangular cross section and has a frame positioned around it in a flange-like manner. The plug-in part, at least to the extent where it is guided through the front plug-in opening, likewise has a rectangular cross section and is preferably made of metal. At least one stop surface, which limits the maximum push-in depth of the plug-in part, is provided inside the housing of the plug-in sleeve, in the rear region, which is located opposite to the front plug-in opening. Likewise inside the housing of the plug-in sleeve is at least one screw seat with a through-opening for the introduction of a fastening screw for fixing the plug-in sleeve. The plug-in sleeve is preferably produced as a single-piece metal casting or plastic injection molding.

At the rear end, which is located opposite the frame, the plug-in sleeve has a rear plug-in opening and retaining contours for the insertion of a first electrical coupling part with a cable routed up into place. The plug-in part has an aperture and retaining contours for the insertion of a second electrical coupling part, with a continuing cable for supplying power to a consuming unit, the two coupling parts, with the plug-in part pushed into the plug-in sleeve to the maximum extent, being intended for engaging mechanically and electrically with one another.

A sleeve holder is provided for accommodating the housing of the plug-in sleeve, this sleeve holder being intended for fastening on the carrying structure of the plug-in sleeve. The sleeve holder has, in the first instance, a housing, which is divided up into a front portion and a rear portion. There is a front plug-in opening, which is accessible from the front portion, and a rear plug-in opening, which is accessible from the rear portion. Flange-like extensions grip the housing at the transition between the front portion and rear portion. The sleeve holder also has at least one crosspiece, which is provided at the free end of the rear portion and has a screw hole for the engagement of the threaded shank of the at least one fastening screw, which fixes the plug-in sleeve and has its head positioned in the screw seat.

The plug-in sleeve is intended for plugging through a through-passage in the panel element, the frame of the plug-in sleeve, this frame enclosing the front plug-in opening, being positioned on the front side of the panel element. The inserted plug-in sleeve is fixed by a sleeve holder, which accommodates the rear part of the plug-in sleeve. The extensions of the sleeve holder are provided with the screw holes therein for screwing on the rear side of the panel element or on a carrying structure erected behind the panel element. The front portion of the sleeve holder can project into the through-passage in the panel element.

As an alternative, the extensions of the sleeve holder, with the screw holes therein, can be utilized for screwing on an outer surface which is directed into space and belongs to a vertical support in the form of a hollow polygonal profile, this vertical support serving as a carrying structure. The rear portion of the sleeve holder then projects into the cavity of the vertical support, and the front portion of the sleeve holder projects into the through-passage in the panel element. Here, too, the frame of the plug-in sleeve, this frame enclosing the front plug-in opening, is positioned on the front side of the panel element.

The rod part of the carrying arm may be a round or quadrilateral tube which is rectilinear or curved or is angled one or more times. As an alternative, the rod part is a round or quadrilateral bar made of solid material. The rod part may bear a shelf which is supported by at least one retaining element, e.g. a transverse strut, at the front end and/or at the plug-in end. In a further configuration, the rod part bears a transverse rod at the front end, it being possible for the transverse rod to be additionally provided with a shelf.

The device according to the invention is distinguished by particular rotational stability even in the case of carrying arms of T-shaped configuration being subjected to a relatively high level of asymmetric loading. Furthermore, the plug-in sleeve, together with the sleeve holder, can be inserted efficiently into different types of carrying structure. Also advantageous is the wide variety of possible configurations in respect of the carrying arms that can be inserted and the way in which they are fitted out. Finally, the device can be cost-effectively mass produced and assembled and, in the process, allows esthetically pleasing arrangements to be erected.

### BRIEF DESCRIPTION OF THE ATTACHED DRAWINGS

In the drawings:

FIG. 1A: shows a side view of a construction comprising a first variant of a sleeve holder in a first application, inserted into the rear side of a panel element, and also comprising a plug-in sleeve accommodated therein and a plugged-in carrying arm;

FIG. 1B: shows a horizontal section along line A-A from FIG. 1A;

FIG. 2A: shows, in perspective, a front view of a first variant of a plug-in sleeve;

FIG. 2B: shows, in perspective, a rear view of the plug-in sleeve according to FIG. 2A;

FIG. 2C: shows, in perspective, a rear view, from beneath, of the plug-in sleeve according to FIG. 2A;

FIG. 3A: shows a plan view of a first variant of a plug-in part of a carrying arm with rod part attached;

FIG. 3B: shows a side view of the plug-in part of a carrying arm with rod part attached according to FIG. 3A;

FIG. 4A: shows, in perspective, a front view of a first variant of a sleeve holder;

FIG. 4B: shows, in perspective, a rear view of the sleeve holder according to FIG. 4A;

FIG. 4C: shows, in perspective, a rear view, from above, of the sleeve holder according to FIG. 4A;

FIG. 5A: shows, in perspective, an exploded illustration of a first variant of a sleeve holder according to FIG. 4A, a first variant of a plug-in sleeve according to FIG. 2A, which has been moved up into close proximity, as seen in the assembly direction, and an associated screw;

FIG. 5B: shows, in perspective, an exploded illustration of the construction according to FIG. 5A, with a panel element introduced between the first variant of the sleeve holder and the first variant of the plug-in sleeve;

FIG. 5C: shows an enlarged horizontal section of the first variant of the sleeve holder according to FIG. 4A in a first application, inserted into the rear side of a panel element, with the first variant of the plug-in sleeve according to FIG. 2A accommodated from the front side;

FIG. 6: shows an enlarged horizontal section of the first variant of the sleeve holder according to FIG. 4A in a second application, fastened on the front side of a carrying structure, with a panel element placed in front and the first variant of the plug-in sleeve according to FIG. 2A accommodated in it;

FIG. 7A: shows the bottom view of the plug-in sleeve of a first variant according to FIG. 2A with, in close proximity, the first variant of the plug-in part of a carrying arm and rod part attached according to FIG. 3A;

FIG. 7B: shows the construction according to FIG. 7A in the plugged-together state;

FIGS. 8A to 8C: show the functional principle of the device in the three positioning phases;

FIG. 8A: shows the first positioning phase: an enlarged vertical section of the construction according to FIG. 1A, with the first variant of the plug-in part of an inclined carrying arm moved up in close proximity to the first variant of the plug-in sleeve;

FIG. 8B: shows the second positioning phase: the construction according to FIG. 8A, with the plug-in part of the inclined carrying arm pushed into the plug-in sleeve to the maximum extent, in the unlocked state;

FIG. 8C: shows the third positioning phase: the construction according to FIG. 8B, with the plug-in part of the horizontally oriented carrying arm pushed into the plug-in sleeve to the maximum extent, in the locked state;

FIG. 9A: shows, in perspective, a front view of a second variant of a plug-in sleeve;

FIG. 9B: shows, in perspective, a rear view of the plug-in sleeve according to FIG. 9A;

FIG. 9C: shows, in perspective, a rear view, from beneath, of the plug-in sleeve according to FIG. 9A;

FIG. 9D: shows, in perspective, a different rear view, from beneath, of the plug-in sleeve according to FIG. 9A;

FIG. 10A: shows, in perspective, a front view of a second variant of a sleeve holder;

FIG. 10B: shows, in perspective, a rear view of the sleeve holder according to FIG. 10A;

FIG. 10C: shows, in perspective, a rear view, from above, of the sleeve holder according to FIG. 10A;

FIG. 10D: shows, in perspective, a rear view, from beneath, of the sleeve holder according to FIG. 10A;

FIG. 11A: shows the bottom view of the second variant of a plug-in sleeve according to FIG. 9A and, in close proximity, the first variant of a plug-in part of the carrying arm according to FIG. 3A;

FIG. 11B: shows an enlargement of the construction according to FIG. 11A in the plugged-together state;

FIG. 12A: shows, in perspective, an exploded illustration of a construction with a panel element introduced between the second variant of the sleeve holder according to FIG. 10A and the second variant of the plug-in sleeve according to FIG. 9A;

FIG. 12B: shows a horizontal section of the sleeve holder according to

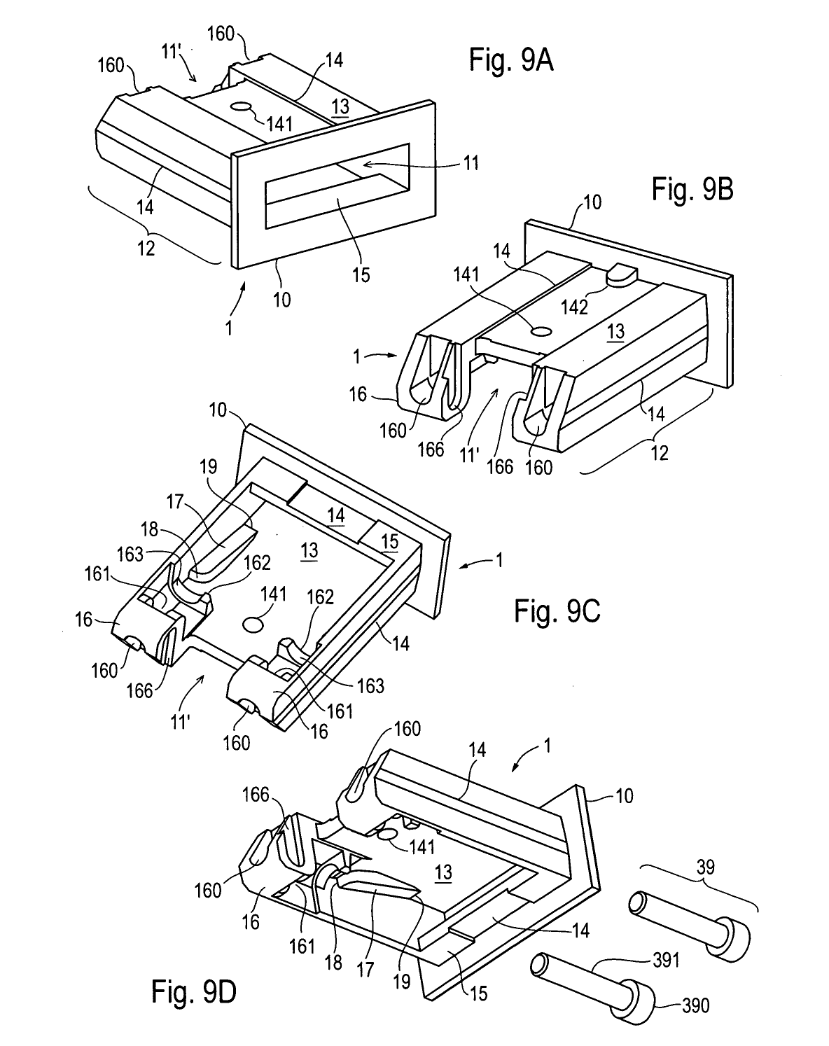

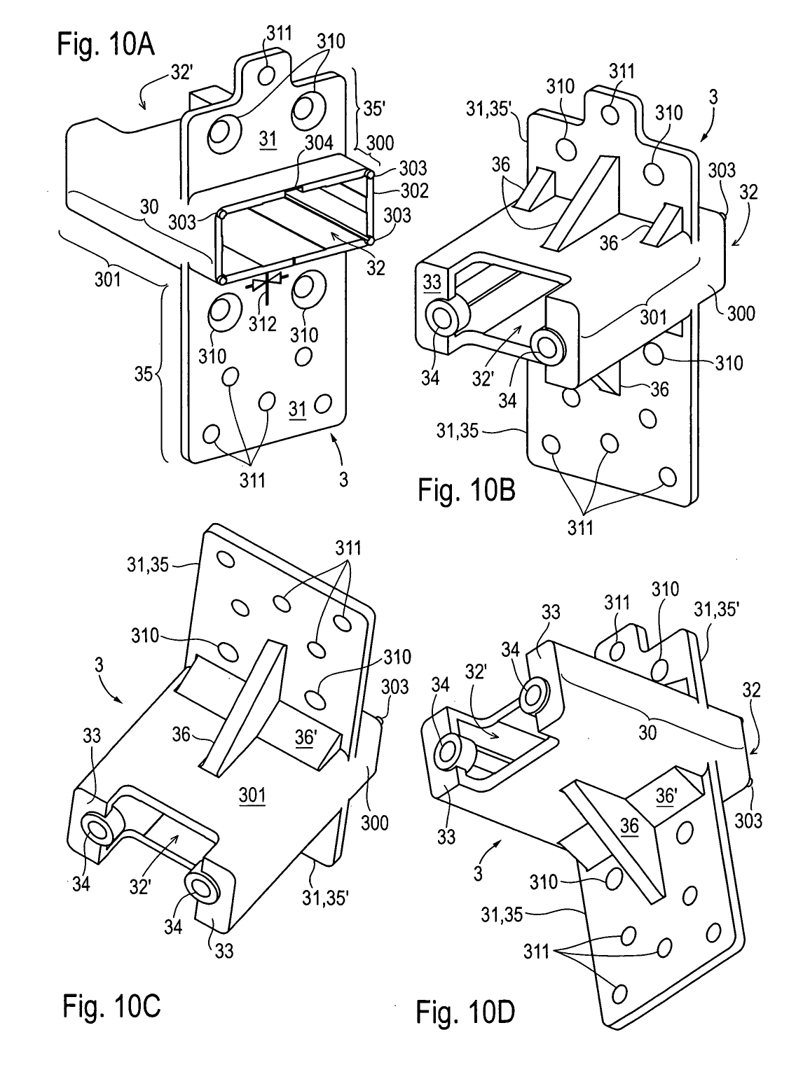

FIG. 10A in a first application, inserted into the rear side of a panel element, with the plug-in sleeve according to FIG. 9A accommodated from the front side;

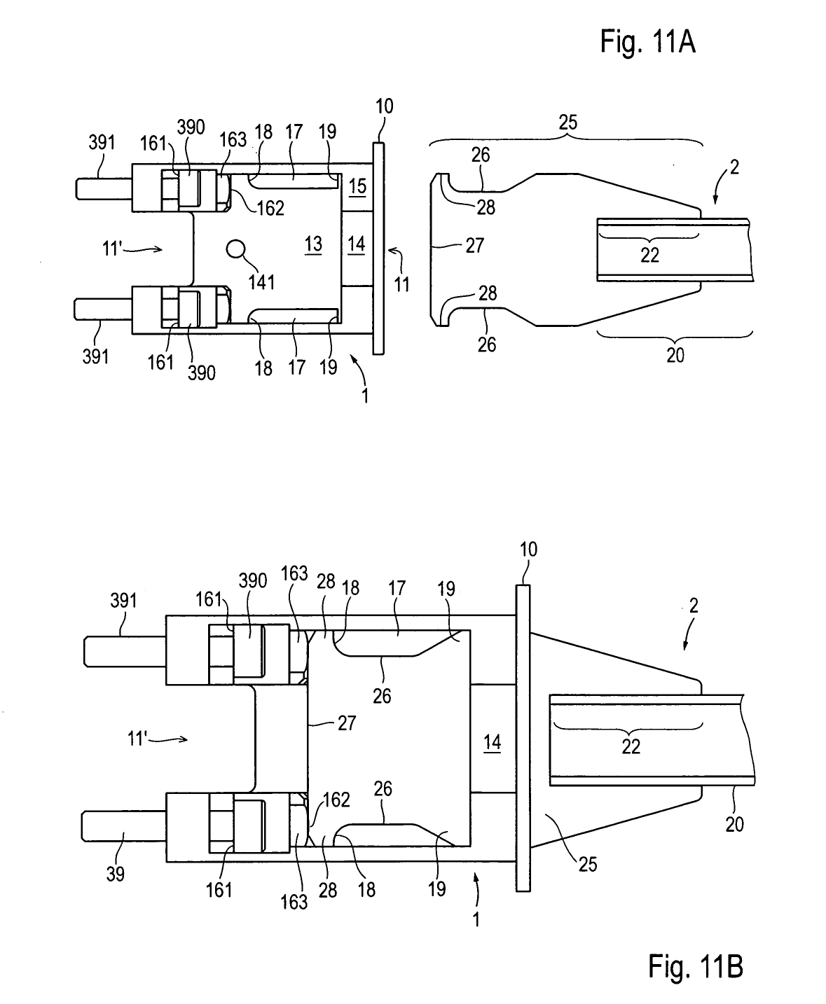

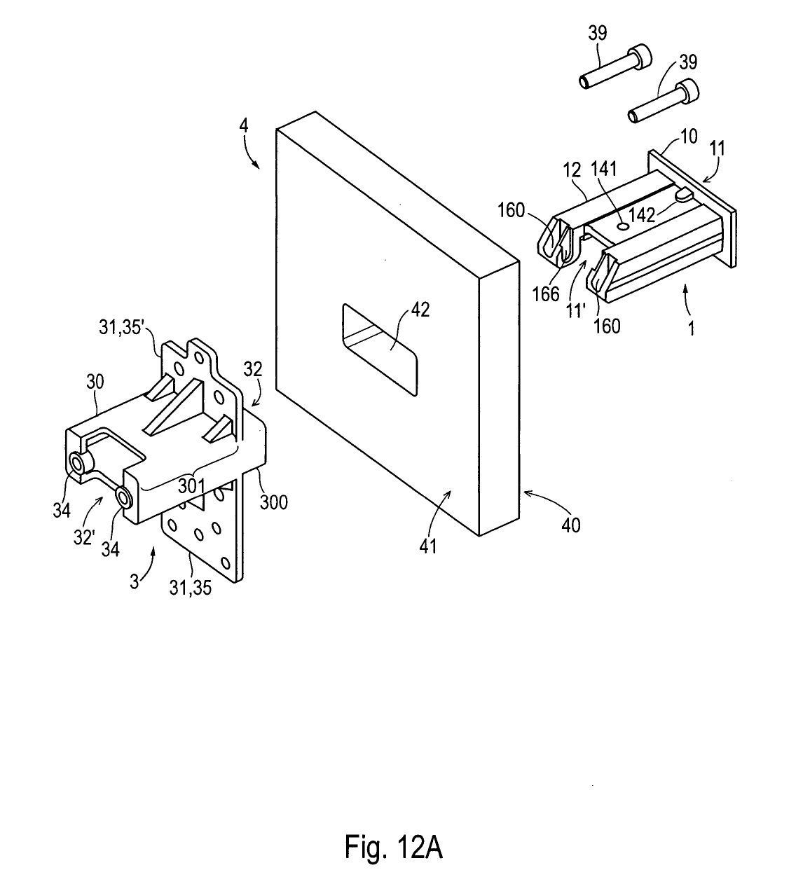

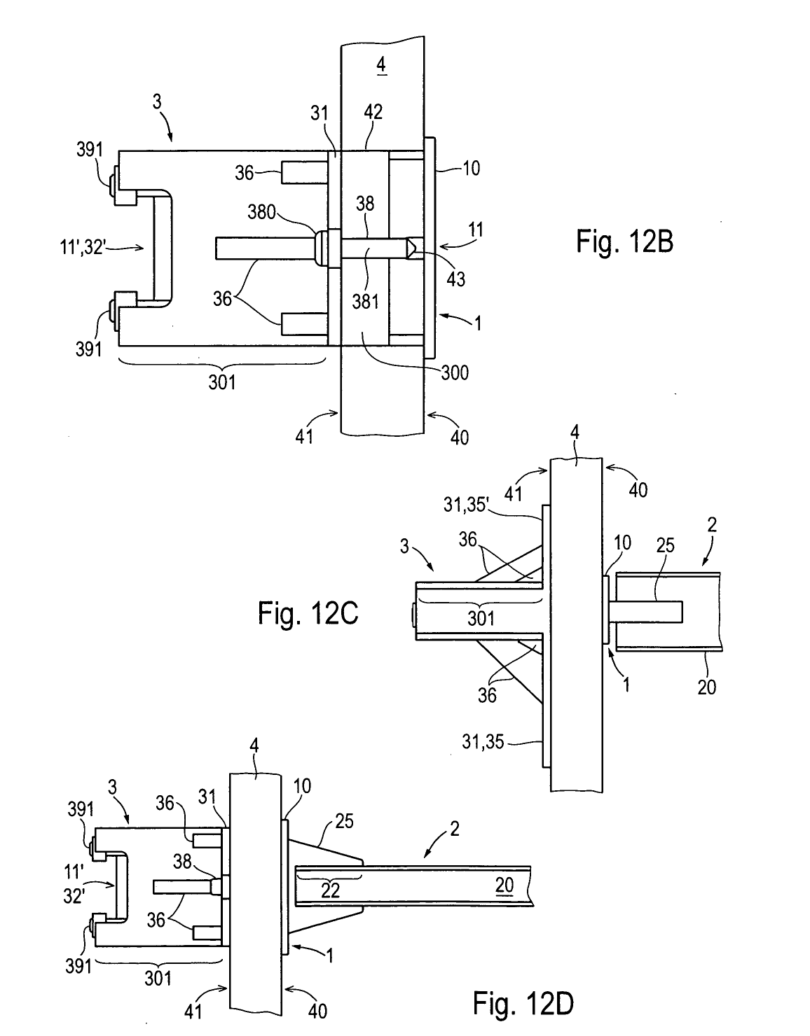

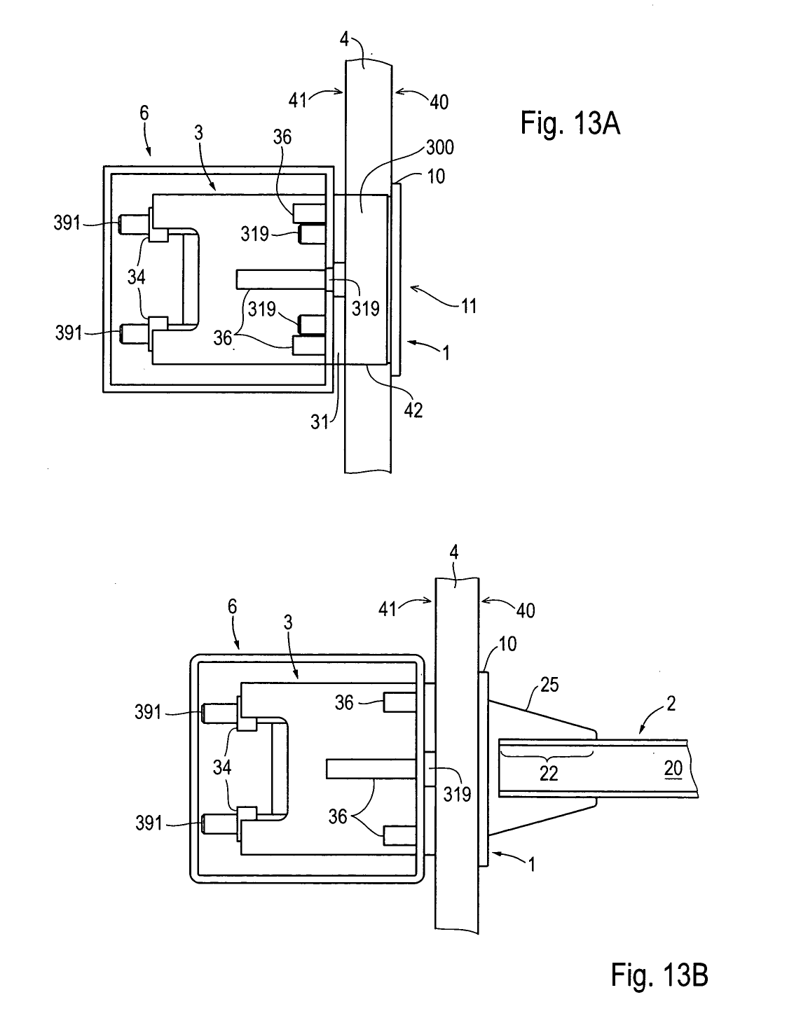

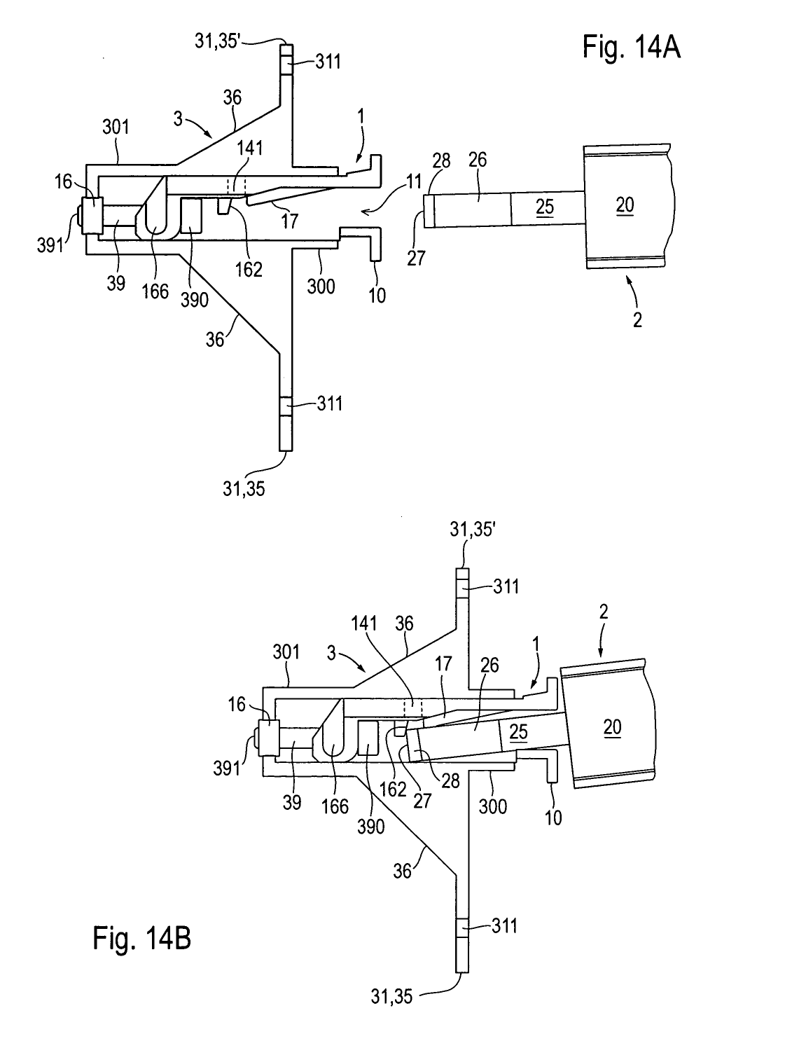

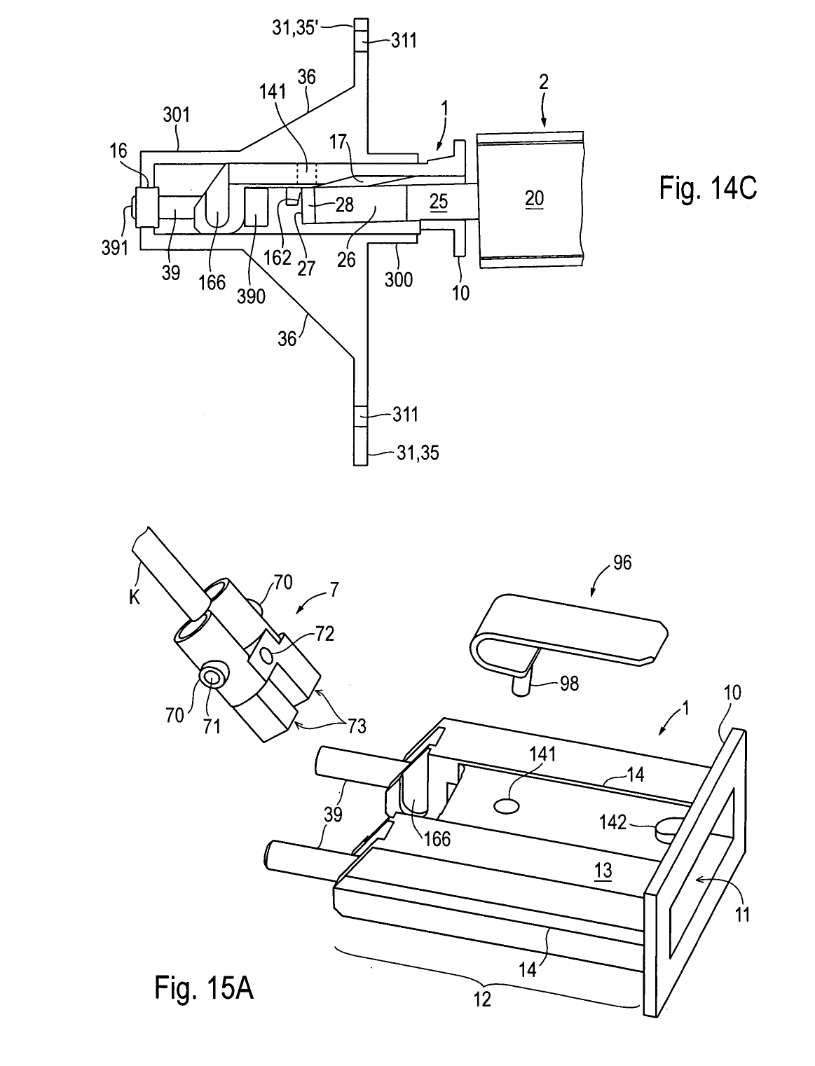

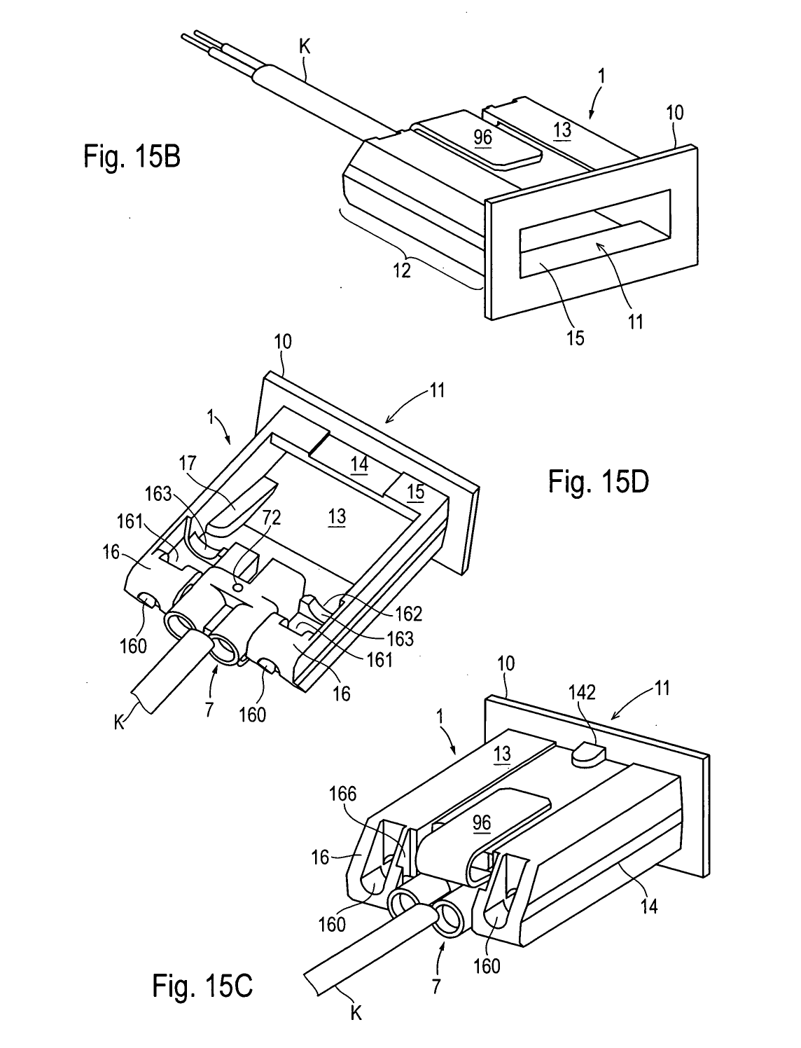

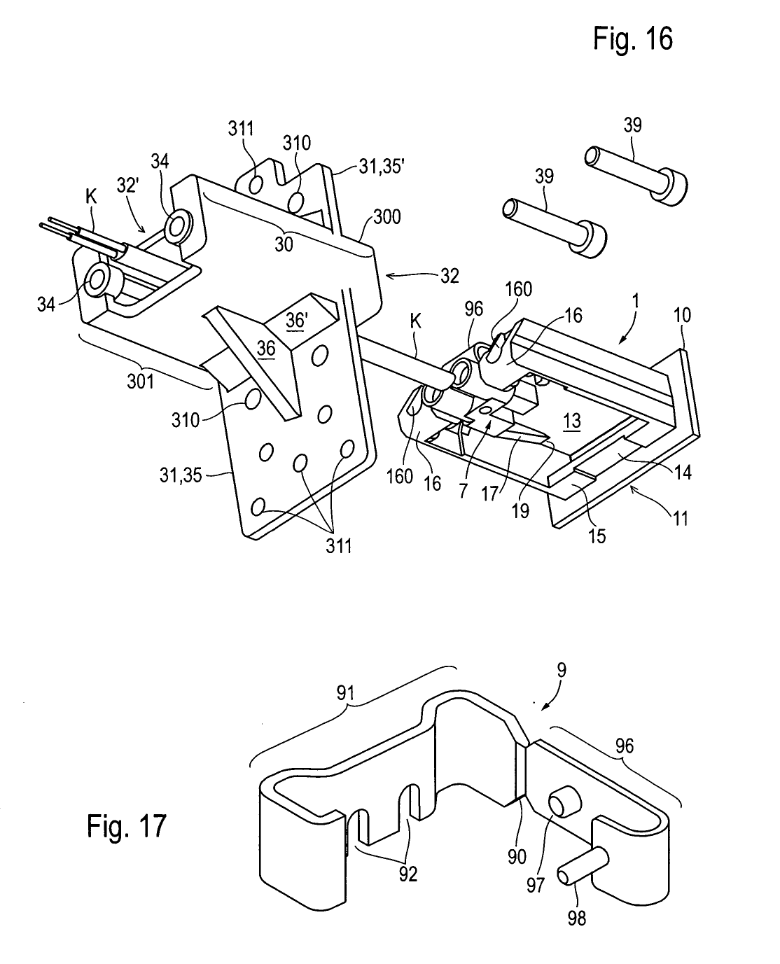

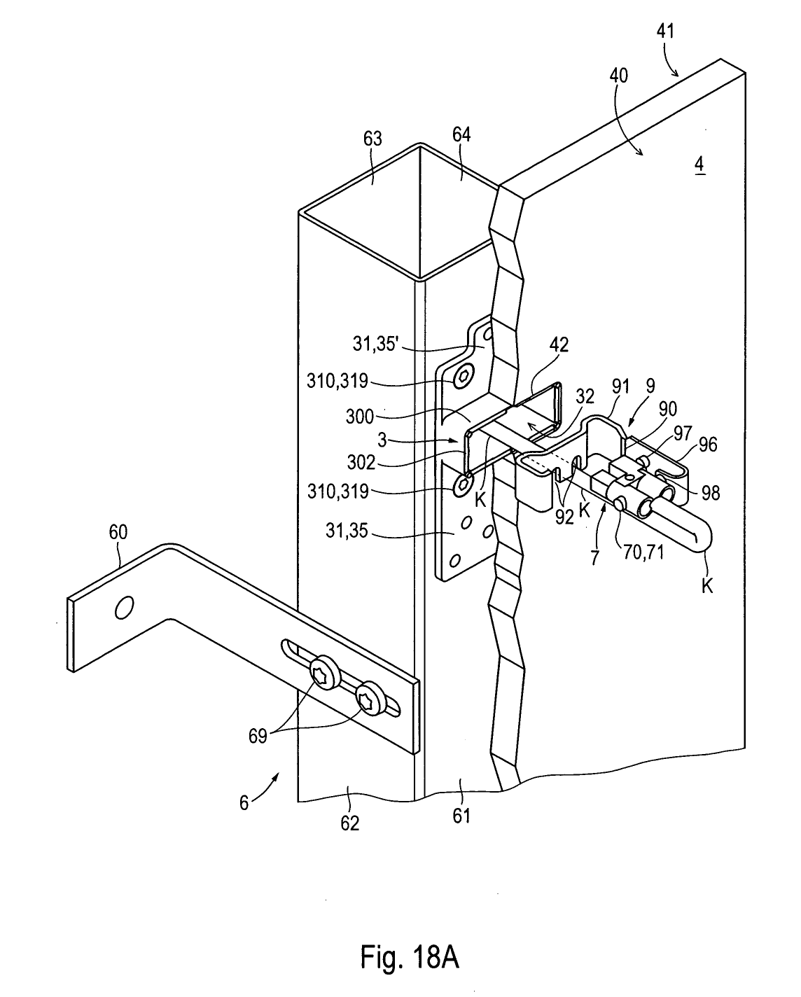

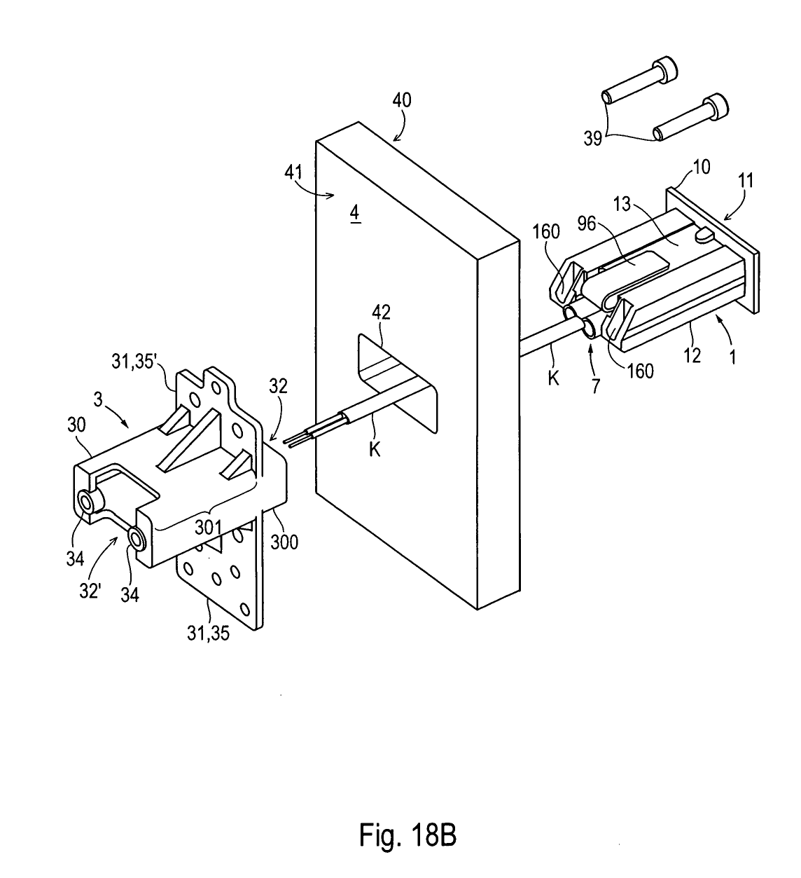

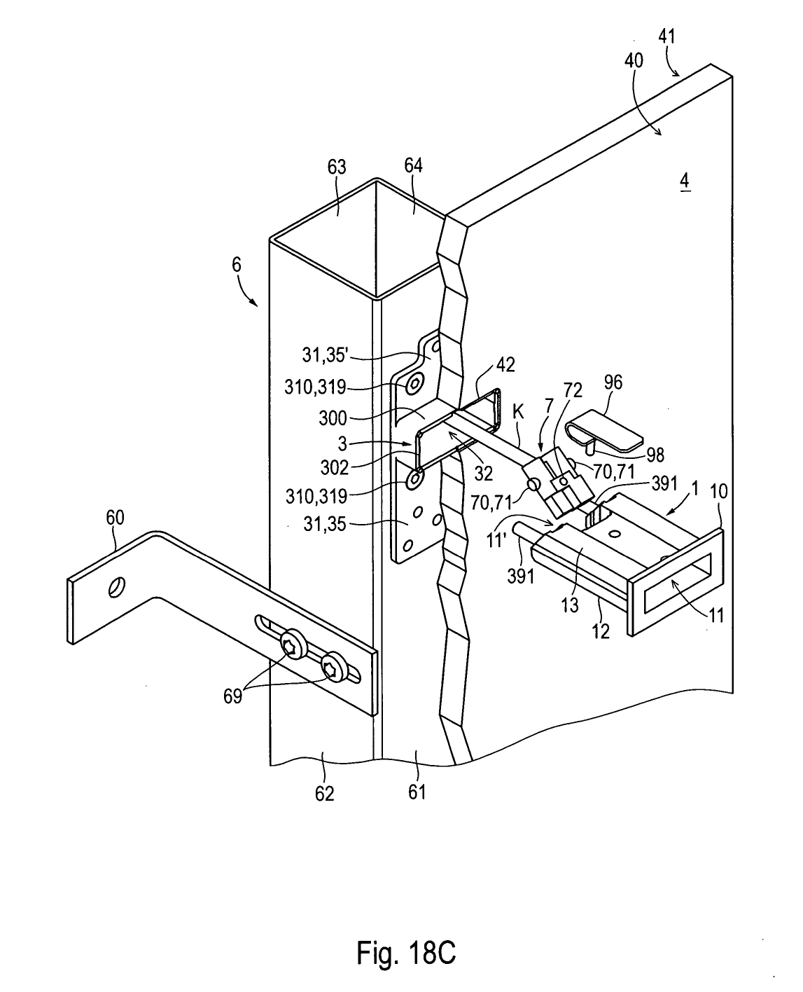

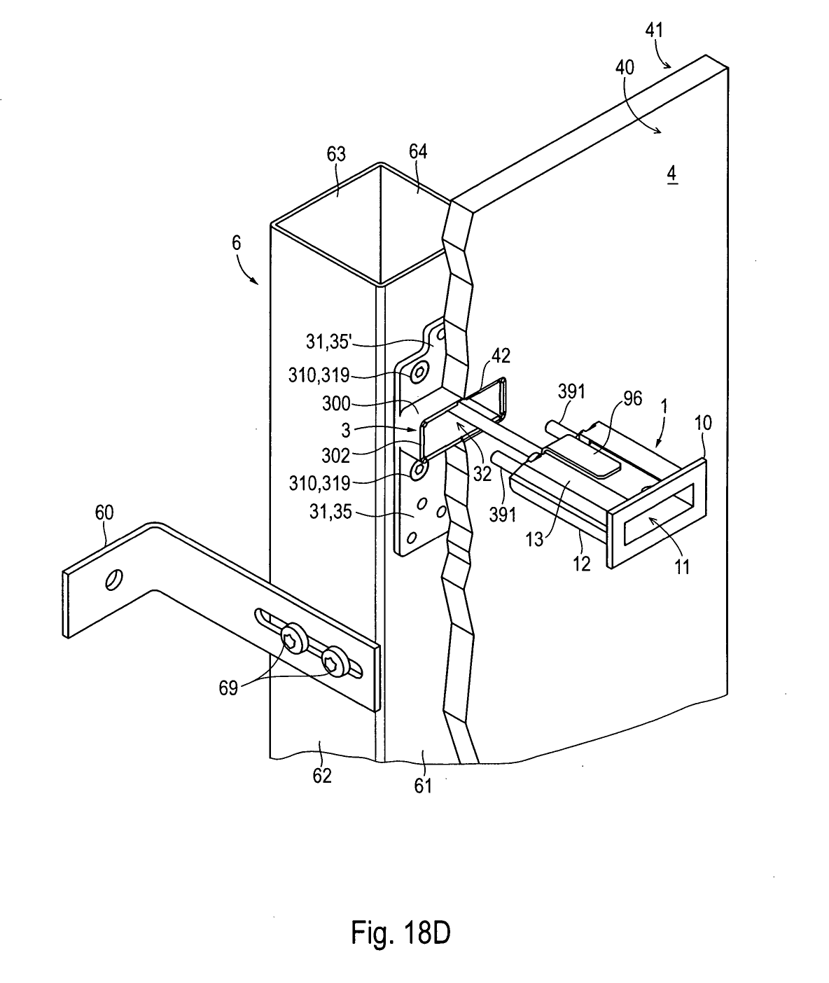

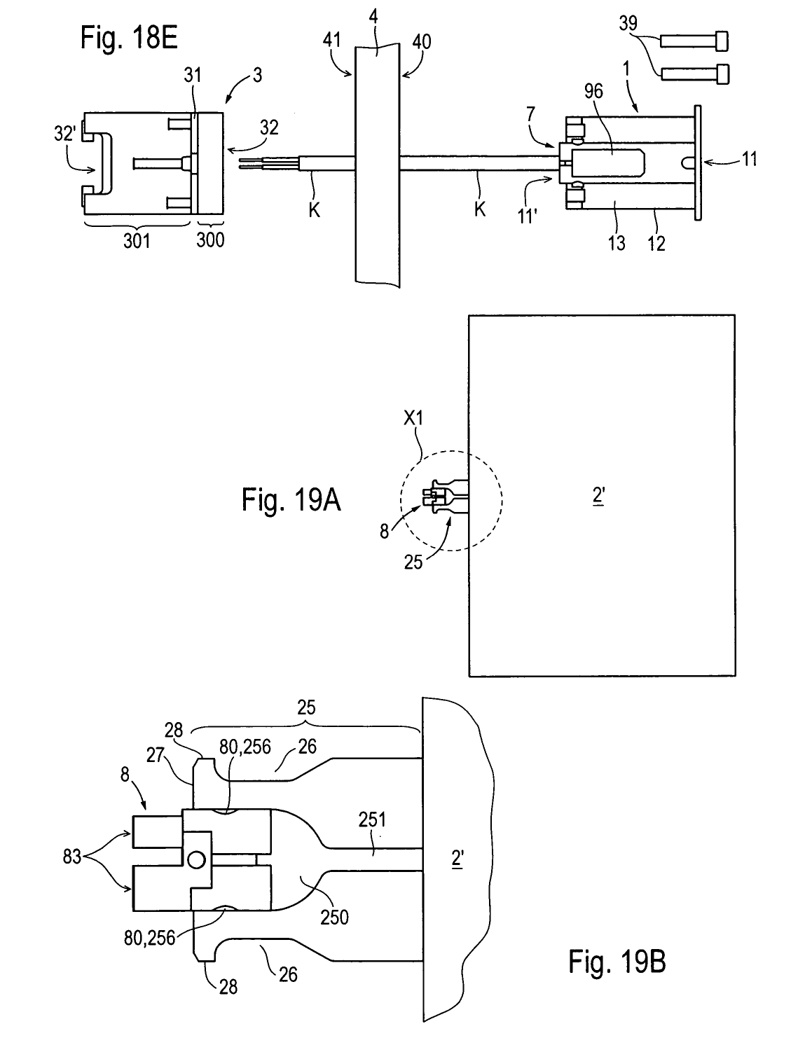

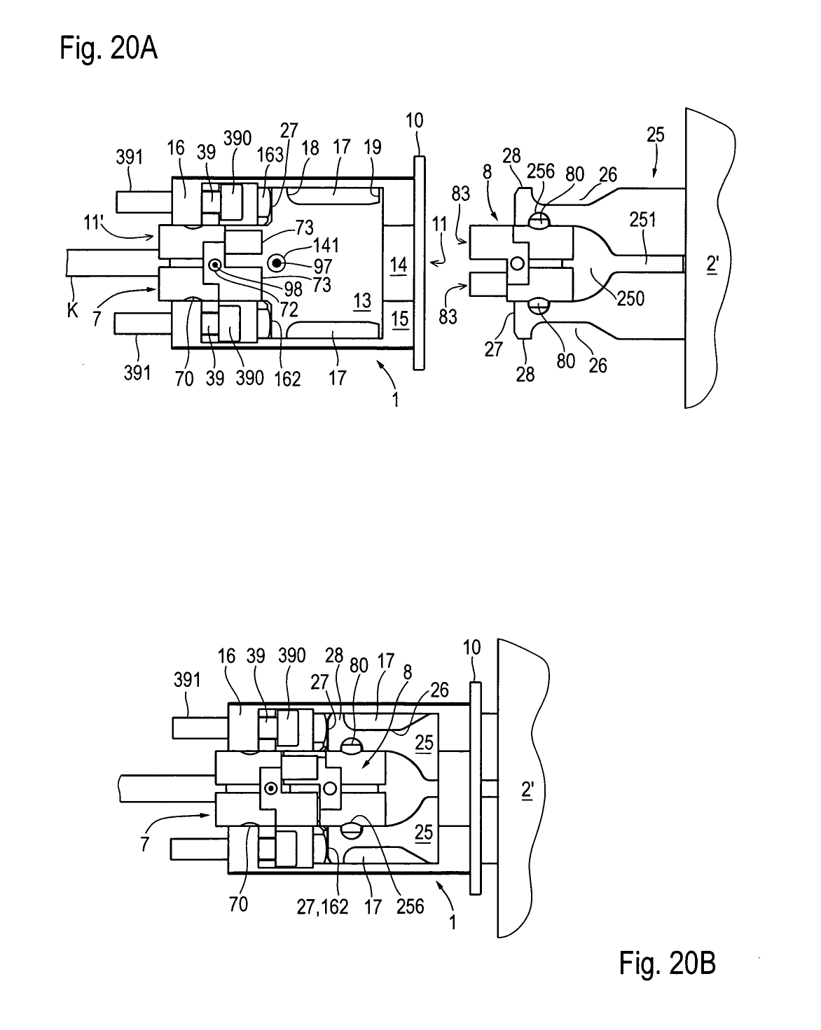

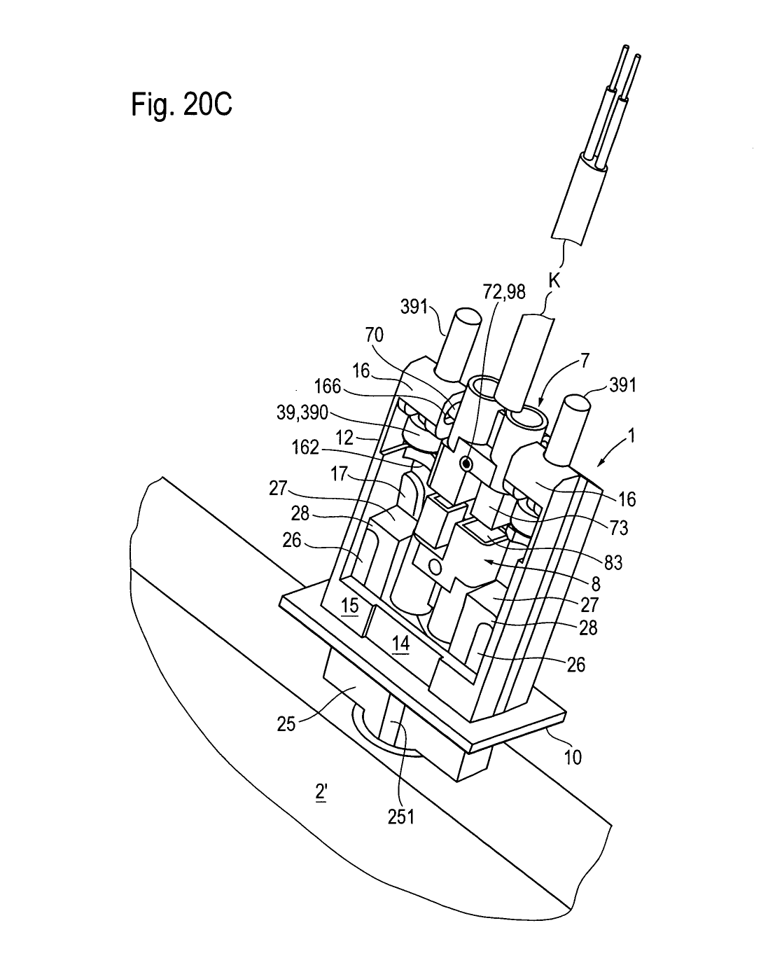

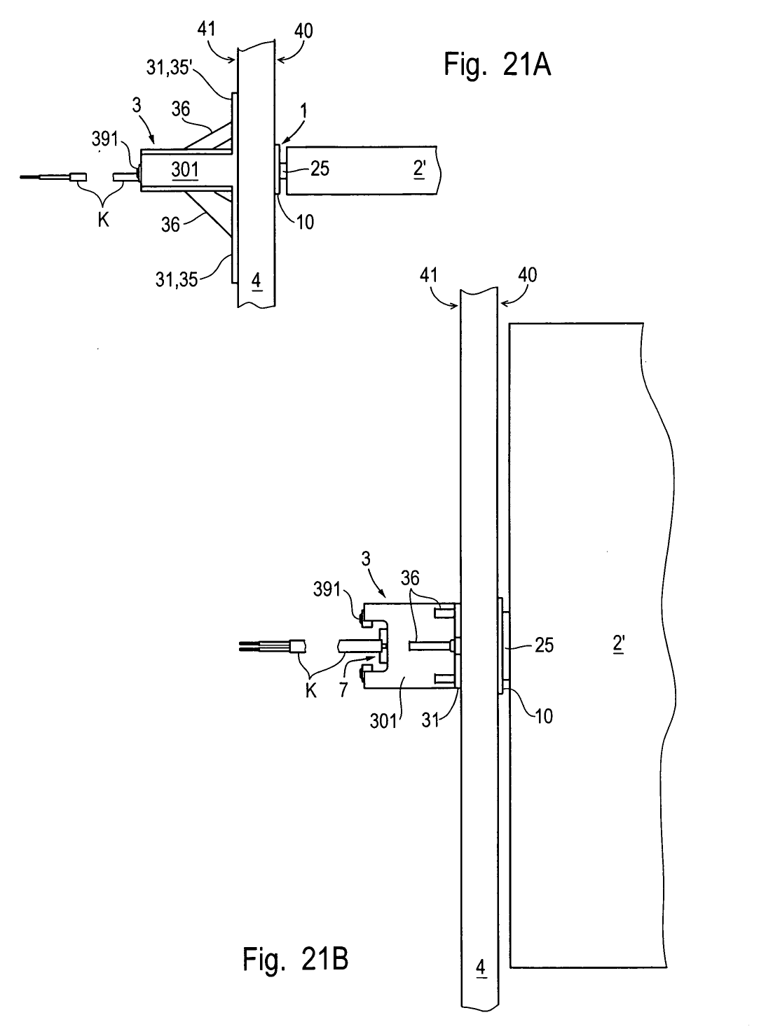

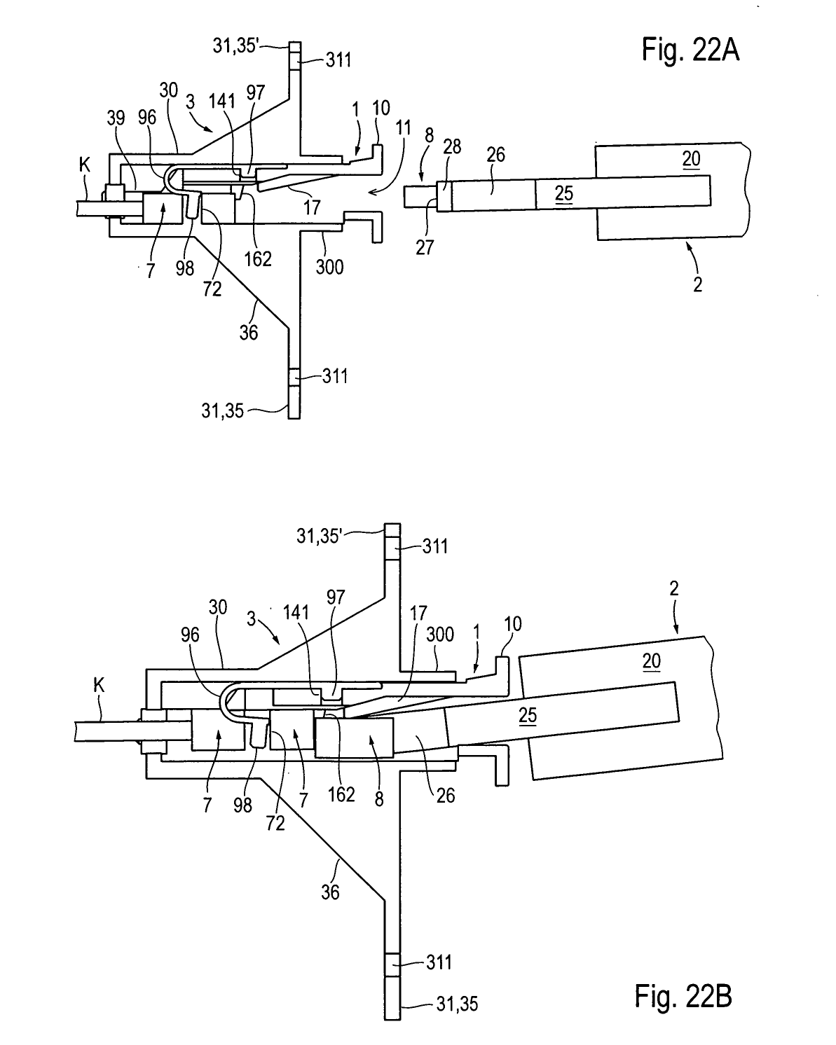

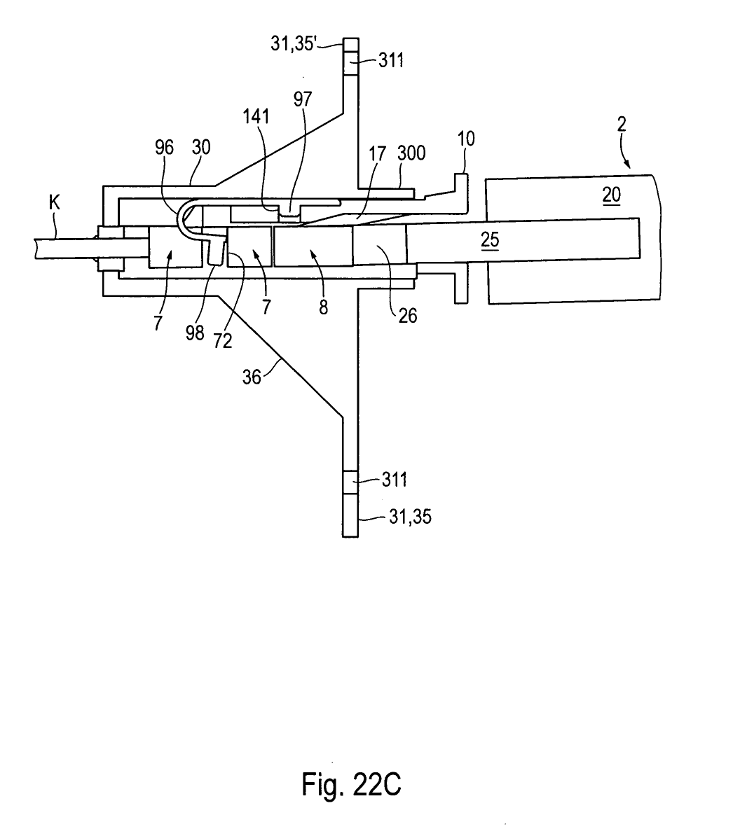

FIG. 12C: shows a vertical section of the construction according to FIG. 12B, with the carrying arm according to FIG. 11A plugged in;

FIG. 12D: shows a horizontal section of the construction according to FIG. 12C;

FIG. 13A: shows a horizontal section of the construction according to FIG. 12B with the second variant of the sleeve holder in a third application, inserted into a vertical support;

FIG. 13B: shows a horizontal section of the construction according to FIG. 13A, with the carrying arm according to FIG. 11A plugged in;

FIGS. 14A to 14C: show the functional principle of the device in the three positioning phases;

FIG. 14A: shows the first positioning phase: a vertical section of the second variant of a sleeve holder according to FIG. 10A, with the second variant of the plug-in sleeve according to FIG. 9A inserted therein and, in close proximity, the first variant of the plug-in part of an inclined carrying arm according to FIG. 11A;

FIG. 14B: shows the second positioning phase: the construction according to FIG. 14A, with the plug-in part of the inclined carrying arm pushed into the plug-in sleeve to the maximum extent, in the unlocked state;

FIG. 14C: shows the third positioning phase: the construction according to FIG. 14B, with the plug-in part of the horizontally oriented carrying arm pushed into the plug-in sleeve to the maximum extent, in the locked state;

FIGS. 15A to 22C: show the device for hanging articles or for securing a bearing means with electrification;

FIG. 15A: shows, in perspective, a side view of the second variant of a plug-in sleeve according to FIG. 9A with, in close proximity, a first coupling part and second clamp part from FIG. 17;

FIG. 15B: shows, in perspective, a front view of the construction according to FIG. 15A in the assembled state;

FIG. 15C: shows, in perspective, the top view of the construction according to FIG. 15B;

FIG. 15D: shows, in perspective, the bottom view of the construction according to FIG. 15B;

FIG. 16: shows a perspective view of the plug-in sleeve with the first coupling part inserted, as a construction according to FIG. 15B, in close proximity to the second variant of a sleeve holder according to FIG. 10A;

FIG. 17: shows a perspective view of a clamp in complete form, with the two clamp parts still interconnected;

FIG. 18A: shows a partial section of a vertical support with the second variant of the sleeve holder according to FIG. 10A inserted therein, in the third application, with preassembled first coupling part, clamp and cable routed up into place;

FIG. 18B: shows a perspective illustration of the construction according to FIG. 12A, with the sleeve holder in the first application, and the first coupling part inserted into the plug-in sleeve and secured by means of the second clamp part;

FIG. 18C: shows a partial section of the construction according to FIG. 18A, with the second clamp part and plug-in sleeve moved up into place;

FIG. 18D: shows a partial section of the construction according to FIG. 18C, with the first coupling part inserted into the plug-in sleeve and secured by means of the second clamp part;

FIG. 18E: shows a plan view of the construction according to FIG. 18B;

FIG. 19A: shows a plan view of a shelf with the second variant of the plug-in part, and second coupling part inserted therein, attached;

FIG. 19B: shows the enlarged detail X1 from FIG. 19A;

FIG. 20A: shows the bottom view of a plug-in sleeve with the first coupling part inserted and secured by means of the second clamp part and, in close proximity, the second variant of the plug-in part with the second coupling part inserted therein, according to the detail X1 from FIG. 19A;

FIG. 20B: shows the bottom view of the construction according to FIG. 20A in the plugged-together state;

FIG. 20C: shows, on an enlarged scale, the perspective view, from beneath, of the construction according to FIG. 20B;

FIG. 21A: shows a vertical section of a sleeve holder according to FIG. 10A in a first application, inserted into the rear side of a panel element, with the plug-in sleeve according to FIG. 9A accommodated from the front side and the shelf according to FIG. 19A secured therein, with electrification;

FIG. 21B: shows a plan view of the construction according to FIG. 21A;

FIGS. 22A to 22C: show the functional principle of the device with electrifycation in the three positioning phases;

FIG. 22A: shows the first positioning phase (electrical coupling parts are at a distance apart from one another): a vertical section of the second variant of a sleeve holder according to FIG. 10A, with the second variant of the plug-in sleeve according to FIG. 9A inserted therein and, in close proximity, the second variant of the plug-in part of an inclined carrying arm;

FIG. 22B: shows the second positioning phase (electrical coupling parts illustrated just prior to engagement): the construction according to FIG. 22A, with the second variant of the plug-in part of the inclined carrying arm pushed into the plug-in sleeve to the maximum extent, in the unlocked state; and

FIG. 22C: shows the third positioning phase (electrical coupling parts are in engagement): the construction according to FIG. 22B, with the second variant of the plug-in part of the horizontally oriented carrying arm pushed into the plug-in sleeve to the maximum extent, in the locked state.

### EXEMPLARY EMBODIMENT

A detailed description will be given hereinbelow of exemplary embodiments of the device according to the invention in different applications and with design-modified components, first of all without, and then with, electrification.

The following applies to the rest of the description. If, in order to avoid ambiguity in the drawings, a figure contains designations which are not explained in the directly associated text of the description, then you are referred to the point at which they are mentioned in previous or subsequent descriptions of the figures. For reasons of clarity, components are not usually designated again in further figures, provided that it is clear from the drawings that they are “recurring” components.

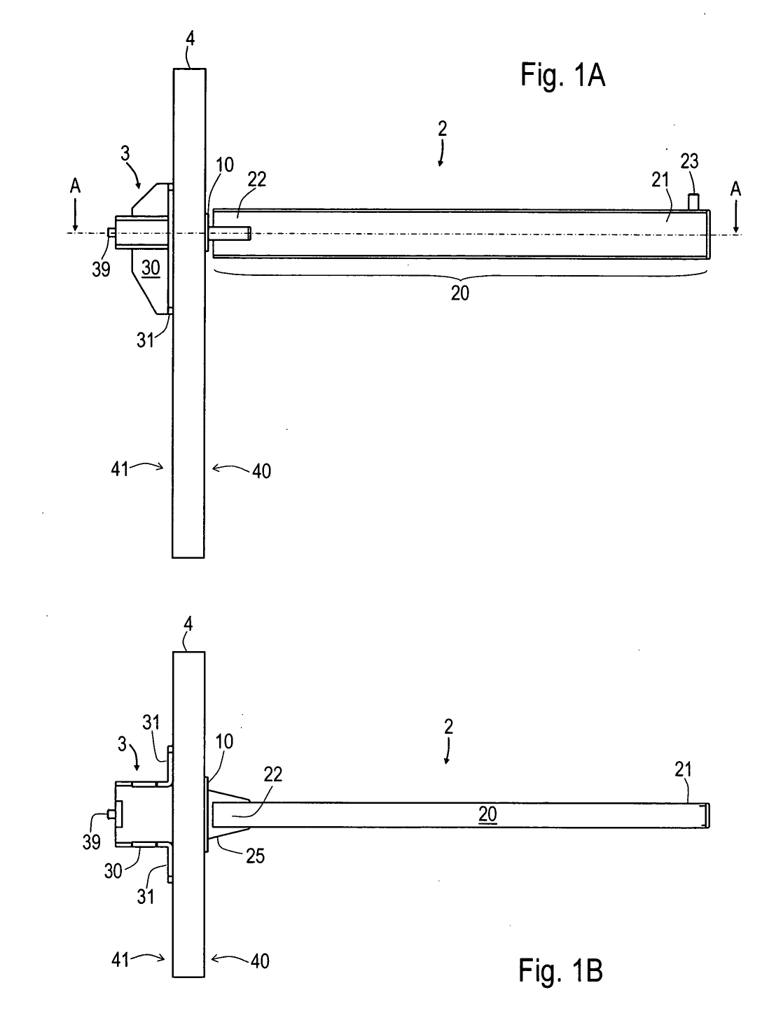

FIGS. 1A and 1B

This pair of figures illustrates a construction which, in the first instance, comprises a first variant of a sleeve holder 3, in a first application, and a first variant of a plug-in sleeve 1 accommodated therein. The sleeve holder 3 is inserted into a panel element 4, by way of its housing 30, from the rear side 41. The plug-in sleeve 1 is accommodated in the sleeve holder 3 from the front side 40 of the panel element 4, so that the frame 10 of the plug-in sleeve 1 ends up located on the front side 40. The combination of sleeve holder 3 and plug-in sleeve 1 rests in a through-passage 42 provided in the panel element 4. The wing-like extensions 31 of the sleeve holder 3, in this first application, are fastened on the rear side 41 of the panel element 4. The plug-in sleeve 1, which is pushed into the sleeve holder 3, is secured by means of an axially provided screw 39.

In the locked, third positioning phase, a carrying arm 2 which is inserted into the plug-in sleeve 1, has its rod part 20 extending, in principle, horizontally into space.

The front end 21 of the carrying arm is particularly provided with a stopper nose 23 in order to avoid the situation where articles which are hung on the carrying arm, e.g. items of clothing hanging on hangers, slide down. Arranged at the plug-in end 22, which is located opposite the front end 21, is a first variant of a plug-in part 25, which is flat in cross section and can be plugged, with arresting action, into the plug-in sleeve 1. The plug-in part 25 and the plug-in opening 11 are preferably of rectangular cross section, this resulting in particularly good rotational stability. The rod part 20, as a tube or bar made of solid material, may have round, oval, rectangular or square cross sections. In addition to the elongate, rectilinear geometry, the rod part 20 may be provided in the curved, stepped or angled forms which are typical for shop construction. In a further alternative, a transverse strut is fitted at the front end 21, so that the carrying arm 2 assumes a T-shaped configuration. It is possible for a transverse strut to extend over the front ends 21 of a plurality of adjacent carrying arms 2, this resulting in a frame-like combination of carrying arms. Articles can be hung directly on the rod part 20 of a carrying arm 2. As an alternative, a bearing means may be arranged, as a shelf, basket or tray for bearing or displaying articles, on an individual rod part 20 or on the rod parts 20 of a plurality of adjacent carrying arms 2.

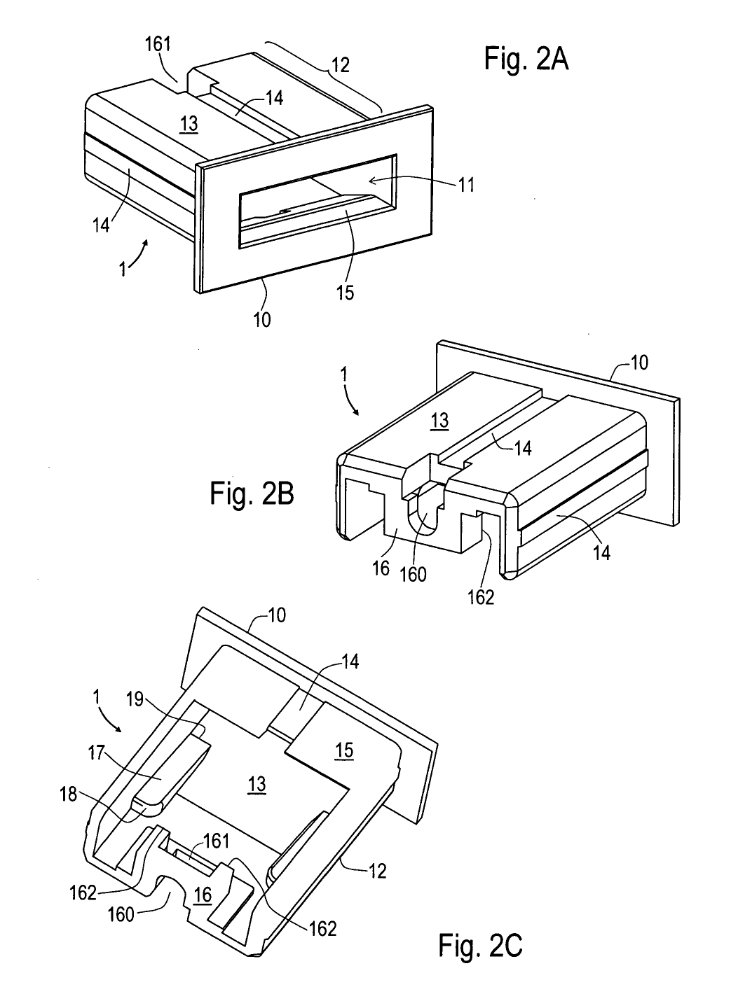

FIGS. 2A to 2C

This series of figures shows different perspective views of a first variant of a plug-in sleeve 1. On the front side, the plug-in sleeve 1 has a flat frame 10, which encloses a window-like plug-in opening 11. Attached to the rear side of the frame 10 is a housing 12 of reduced cross section, so that the frame 10, in its plane, forms a flange-like projection on all sides. The housing 12 is basically in the form of a cuboid which has the plug-in opening 11 toward the front and is partially open toward the bottom and rear, i.e. the ceiling 13 is closed apart from a screw seat 161, a ledge 16 projects into the rear side, which is located opposite the frame 10, and a base section 15 is adjacent to the frame 10, so that most of the base surface area is open. In the axial direction, the ceiling 13 and the base section 15 have guide contours 14, preferably designed as grooves. The guide contours 14 on the side flanks of the housing 12, in contrast, are preferably elevated crosspieces. The axial through-opening 160 with the screw seat 161 extends through the ledge 16. The ledge 16 has stop surfaces 162 directed into the interior of the housing 12.

Provided on the underside of the ceiling 13, adjacent to the side flanks of the housing 12 in each case, is an internal arresting contour 17 with an inlet 19, which is directed toward the frame 10, and a buffer edge 18, which is directed toward the ledge 16. The arresting contour 17 extends with wedge-like thickening from the inlet 19—from the flat plane of the ceiling 13—in the direction of the buffer edge 18, so that the arresting contour 17 increases in height in the direction of the buffer edge 18. The plug-in sleeve can be produced in a particularly advantageous manner by plastic injection molding.

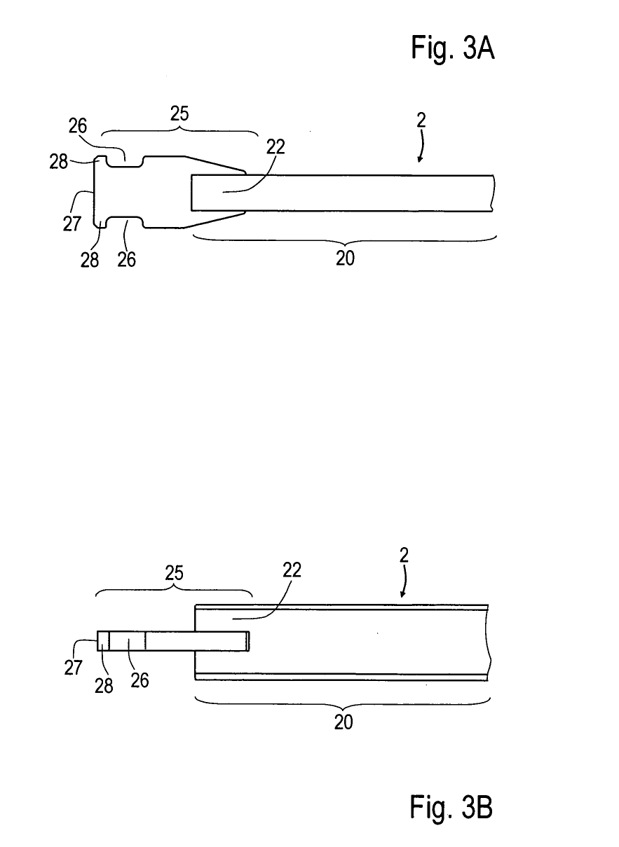

FIGS. 3A and 3B

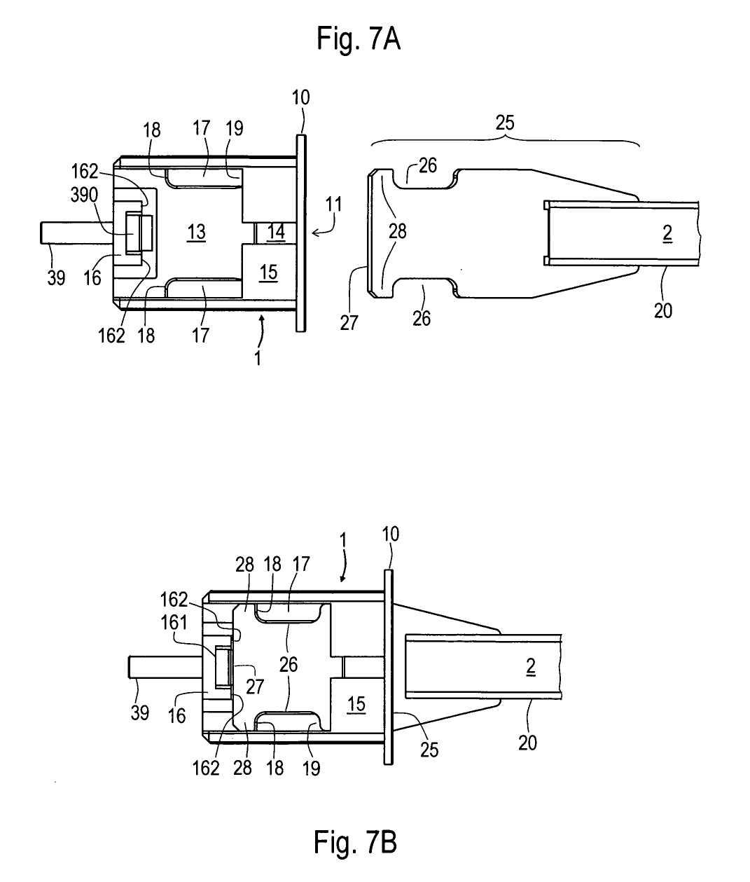

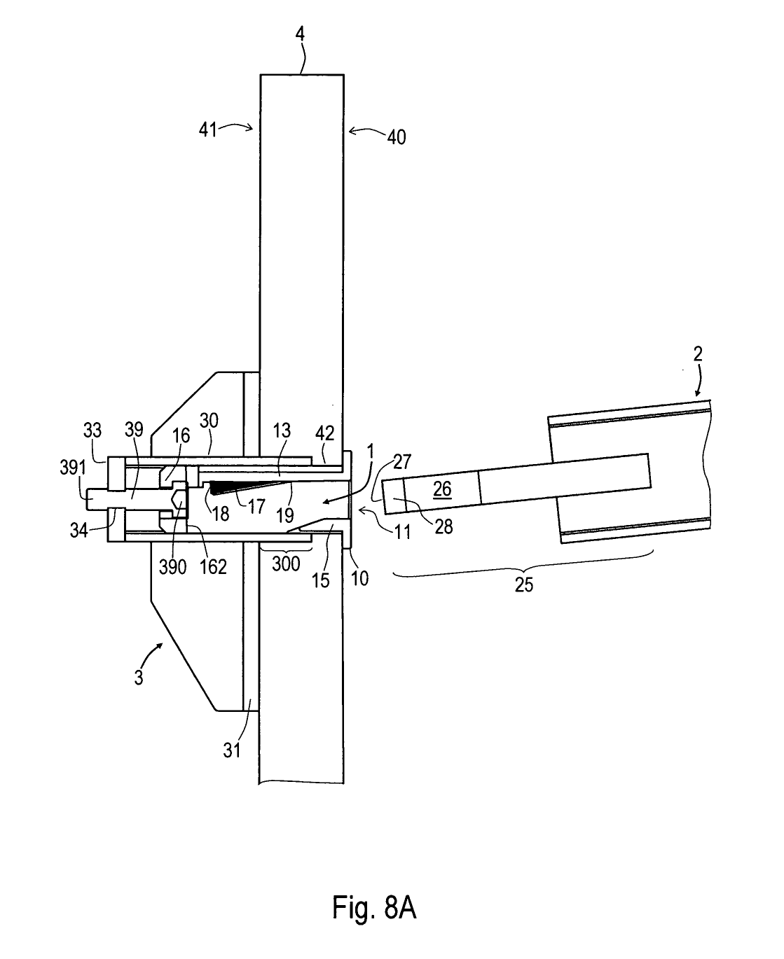

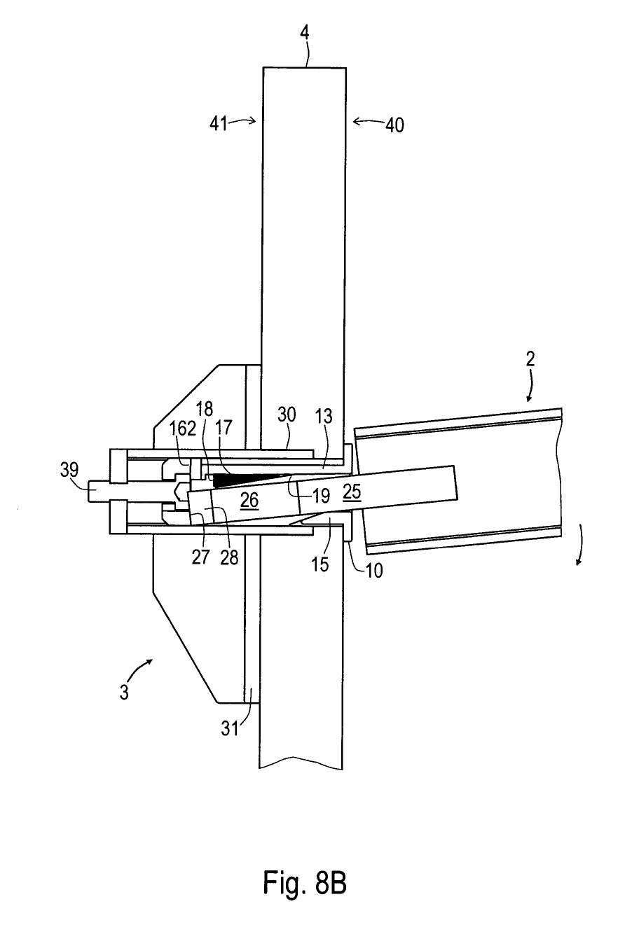

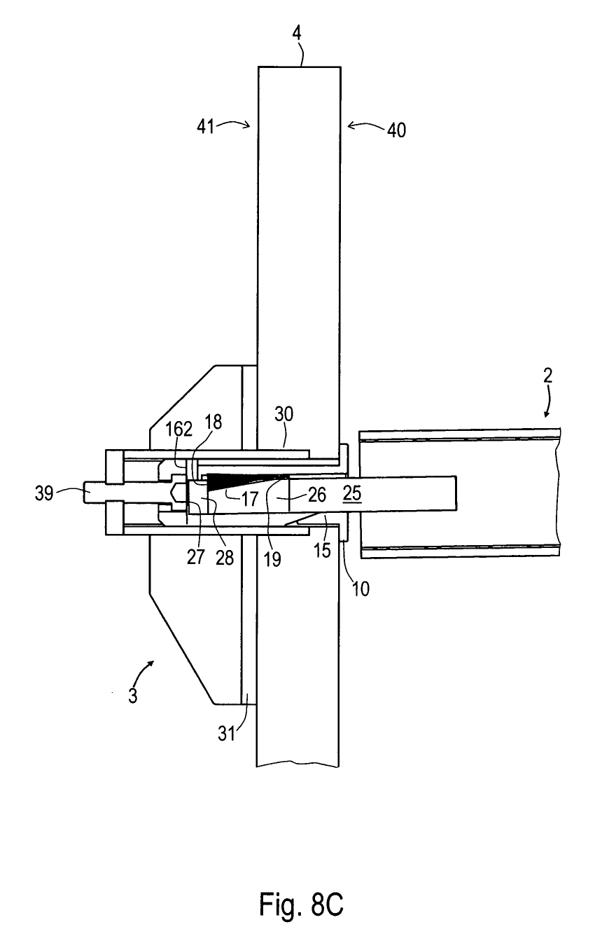

The first variant of the plug-in part 25 is fixed to the plug-in end 22 of the rod part 20 and has a cross section which complements the plug-in opening 11 of the plug-in sleeve 1 and is flat in the horizontal plane. The plug-in part 25 terminates with the free end 27. Provided in the two side flanks of the plug-in part 25 is a respective mating contour 26, which is set back from the end 27 and is preferably designed as undercut depressions in which, in the plugged-in state (see FIGS. 7B and 8C), the arresting contours 17, of complementary dimensions, end up located. Outer claws 28 thus form in the corner regions in front of the two mating contours 26, as seen in the direction of the end 27. For subjecting the device as a whole to high loading, the entire carrying arm 2 with the plug-in part 25 will be produced from a material with corresponding load-bearing properties, e.g. steel.

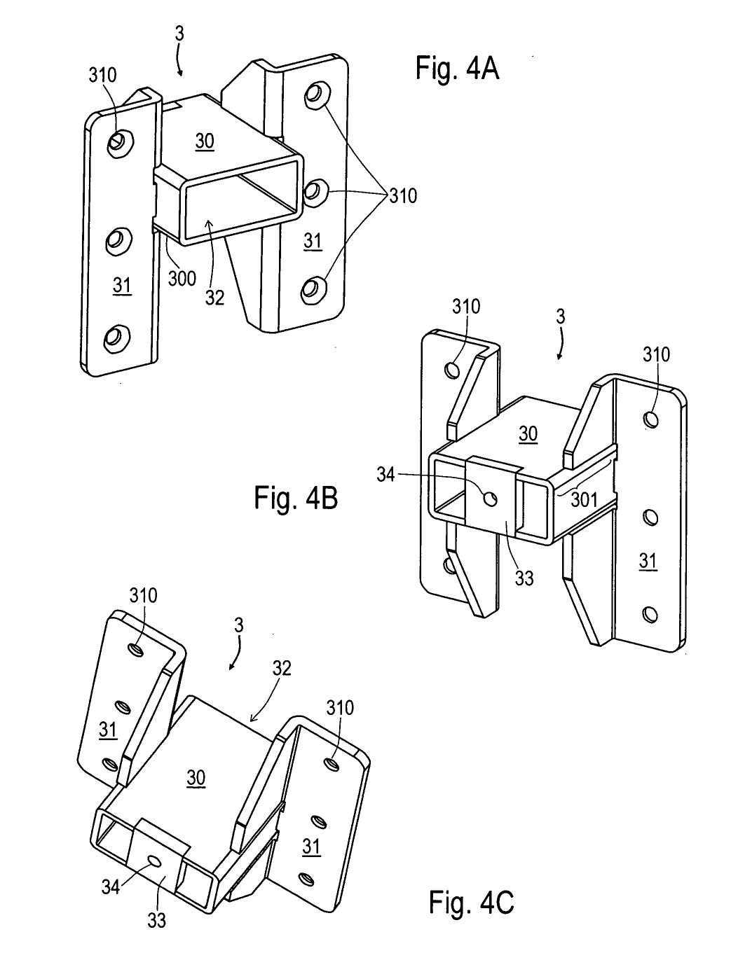

FIGS. 4A to 4C

The first variant of the sleeve holder 3, which is dealt with in this series of figures, with its housing 30 and the extensions 31 encasing the housing 30 in a wing-like manner serves for fixing a plug-in sleeve 1 which is inserted therein. Corresponding to the housing 12 of the plug-in sleeve 1, the housing 30 has a plug-in opening 32 and an internal accommodating space. On the rear side of the housing 30, that is to say located opposite the plug-in opening 32, a centrally arranged vertical crosspiece 33 partially closes the rear exit from the housing 30. A screw hole 34 is provided in the center of the crosspiece. The vertically positioned, angled extensions 31 define a vertical plane which is set back in relation to the plug-in opening 32 and from which the front portion 300 extends to the front and the rear portion 301 of the housing 30 extends to the rear. The extensions 31 contain a plurality of screw holes 310 which serve for fastening the sleeve holder 3 on the rear side 41 of a panel element 4, in the first application, or in front of a carrying structure 5, in the second application. In order to support relatively high loading, the extensions 31 extend beyond the housing 30 in the upward and downward directions.

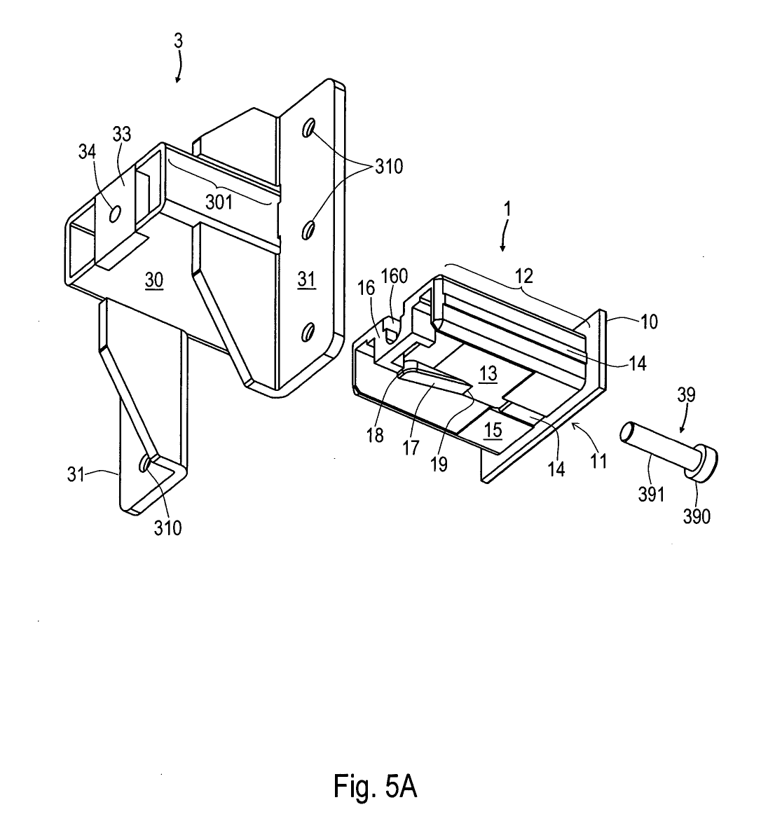

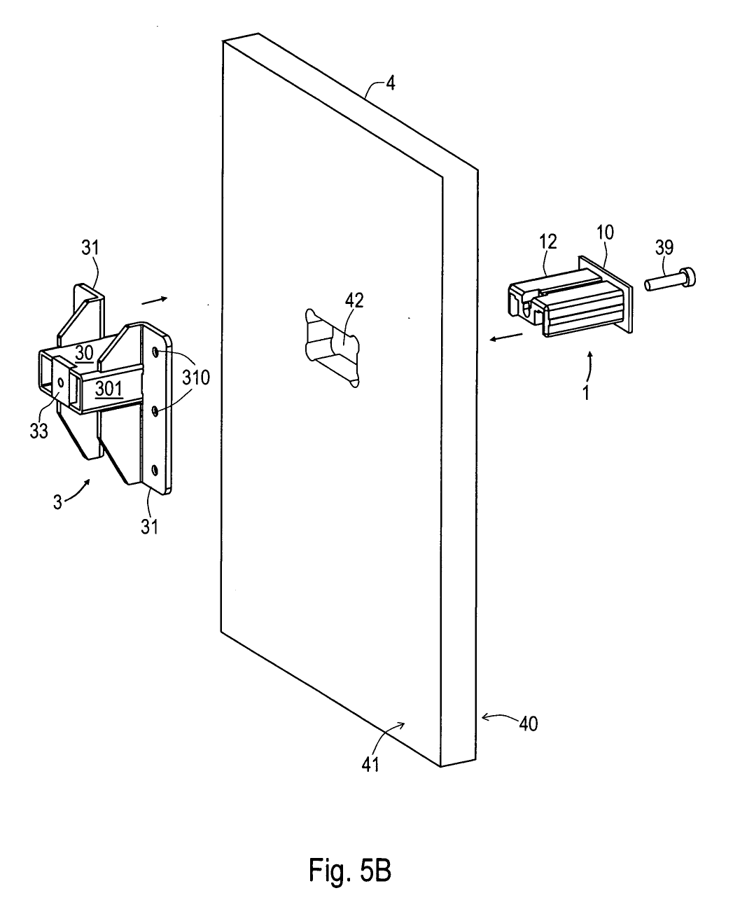

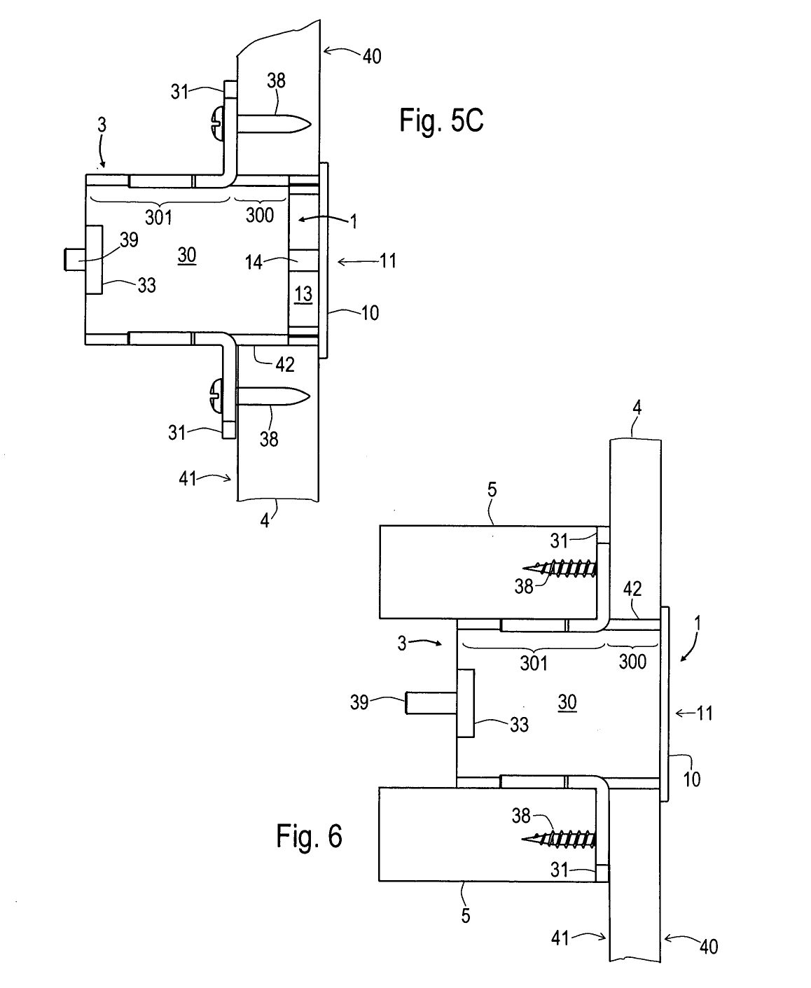

FIGS. 5A to 5C

For assembling the first variant of the plug-in sleeve 1 and the first variant of the sleeve holder 3, in the first application, the sleeve holder 3 is positioned, by way of its two extensions 31 on the rear side 41 of a panel element 4, so that the front portion 300 of the sleeve holder 3 projects into an appropriately dimensioned through-passage 42 in the panel element 4, while the rear portion 301 of the sleeve holder 3 projects away from the rear side 41 of the panel element 4. The extensions 31 are fastened by means of screws 38 which engage through the screw holes 310 into the panel element 4. From the front side 40 of the panel element 4, the plug-in sleeve 1 is pushed into the plug-in opening 32 of the sleeve holder 3—with the housing 12 in front, the ceiling 13 upward and the base section 15 downward—until the flange-like frame 10 of the plug-in sleeve 1 is positioned on the front side 40 and, in the process, covers over the border of the through-passage 42.

A screw 39 is introduced in order to secure the plug-in sleeve 1 accommodated in the sleeve holder 3, the head 390 of the screw ending up located in the screw seat 161 of the ledge 16 of the plug-in sleeve 1, and its threaded shank 391 projecting through the through-opening 160 and engaging in the screw hole 34 of the rear crosspiece 33 in the sleeve holder 3. The sleeve holder 3 and plug-in sleeve 1 are thus assembled, so that the plug-in opening 11 of the plug-in sleeve 1 is thus ready for the introduction of the plug-in part 25 of a carrying arm 2 from space in the direction of the front side 40 of the panel element 4. Panel elements 4 of different thicknesses can be used for the sleeve holder 3 with the front portion 300 of a certain length, so that the front edge of the front portion 300 in the through-passage 42 extends, at most, as far as the front side 40 of the panel element 4 or, in the case of a smaller panel thickness, ends up located in a set-back position in the through-passage 42.

FIG. 6

In the case of the alternative, second application of the first variant of the sleeve holder 3, the latter, rather than being screwed to the rear side 41 of the panel 4, is fastened by way of its extensions 31, preferably once again by means of screws 38, on a carrying structure 5 arranged on the rear side of the panel element 4. Such a carrying structure 5 could comprise, for example, two spaced-apart struts, between which the sleeve holder 3 is accommodated, or a framework component with an aperture for the insertion of the rear portion 301 of the sleeve holder 3. Here, too, the front portion 300 of the sleeve holder 3 is introduced into a complementary through-passage 42 and, depending on the thickness of the panel element 4 used, penetrates into the same, but at most into the plane of the front side 40. In the same way as with the first application, the plug-in sleeve 1 is pushed into the plug-in opening 32 of the sleeve holder 3—with the housing 12 in front, the ceiling 13 upward and the base section 15 downward—from the front side 40 of the panel element 4 until the frame 10 of the plug-in sleeve 1 ends up resting on the front side 40 and covers the border of the through-passage 42.

FIGS. 7A and 7B

This pair of figures illustrates the form-fitting engagement of the first variant of the plug-in part 25 of the carrying arm 2 introduced into the end position in the first variant of the plug-in sleeve 1. In the initially unoccupied state, the plug-in opening 11 of the plug-in sleeve 1 and the arresting contours 17 on the underside of the ceiling 13 and also the stop surfaces 162, which are located opposite the plug-in opening 11 inside the plug-in sleeve 1, are free (see FIG. 7A).

Once the carrying arm 2 has been introduced into the plug-in sleeve 1 with the plug-in part 25 in front, and the carrying arm 2 oriented basically horizontally, the two arresting contours 17, passing from the inlet 19 to the buffer edge 18, end up located entirely in the complementary, cut-out mating contours 26 of the plug-in part 25. The two outer claws 28 are seated behind the buffer edges 18. The end 27 of the plug-in part 25 is positioned in front of the stop surfaces 162 and the rest of the plug-in part 25 extends out of the plug-in sleeve 1, through the plug-in opening 11 thereof, and merges into the rod part 20 of the carrying arm 2.

FIGS. 8A to 8C

This series of figures explains the functional principle of the device, which, in the respectively first variant of the plug-in sleeve 1 and of the sleeve holder 3, is not electrified, in the three characteristic positioning phases.

First Positioning Phase: Inclined Position of Close Proximity (FIG. 8a)

In preparation for the insertion of the carrying arm 2 into the unoccupied plug-in sleeve 1, its plug-in part 25, on which are located the two mating contours 26 and the respectively adjacent outer claws 28, is moved up, with the end 27 in front, into close proximity with the free plug-in opening 11, which is accessible from the front side 40 of the panel element 4 and is enclosed by the frame 10. It is likewise the case that the two arresting contours 17 with the respective inlet 19 and the buffer edge 18 on the underside of the ceiling 13 of the housing 12 are still unoccupied and project freely into space. It is also the case that the stop surfaces 162 inside the plug-in sleeve 1, the stop surfaces being provided on the ledge 16, are free. The carrying arm 2 has to be inclined in relation to the horizontal overall, with the plug-in part 25 in a lowered position and the front end 21 of the rod part 20 in a raised position (see FIG. 1A).

The plug-in sleeve 1 is oriented horizontally in the panel element 4, the assembly which is shown here corresponding to the first application (see FIGS. 5B and 5C), i.e. the sleeve holder 3 is fastened, by way of its extensions 31, on the rear side 41 of the panel element 4. The front portion 300 of the housing 30 of the sleeve holder 3 projects from the rear side 41 of the panel into the through-passage 42. The plug-in sleeve 1 is fastened in the sleeve holder 3 by means of the screw 39, of which the head 390 is seated in the ledge 16 and the threaded shank engages in the screw hole 34 in the crosspiece 33.

Second Positioning Phase: Unlocked State (FIG. 8B)

The plug-in part 25, with the end 27 of the inclined carrying arm 2 in a lowered position, is pushed in through the plug-in opening 11, beyond the base section 15, until the end 27 rests against the stop surfaces 162. As the plug-in part 25 is pushed in, those surfaces of the outer claws 28 which are directed toward the arresting contours 17 move along first of all beneath the two inlets 19 and then gradually beneath the two wedge-shaped arresting contours 17. The outer claws 28, which usually slide along the arresting contours 17, force the still-inclined position of the carrying arm 2 as a whole to be maintained. The maximum push-in depth of the plug-in part 25 is thus achieved and, at the same time, the two mating contours 26, provided on the side flanks of the plug-in part 25, and the outer claws 28 are positioned congruently beneath the two complementary arresting contours 17.

Third Positioning Phase: Locked State (FIG. 8C)

Starting from the second positioning phase according to FIG. 8B, the plug-in part 25, pushed into the plug-in sleeve 1 to the maximum extent, with the adjoining rod part 20, which extends between its plug-in end 22 and front end 21 and, along with the plug-in part 25, produces the carrying arm 2, is moved out of the inclined position, as a whole, into the horizontal. In this case, the two arresting contours 17 pass into the mating contours 26, as a result of which the outer claws 28 of the plug-in part 25 grip behind the buffer edges 18 on the plug-in sleeve 1.

The end 27 of the plug-in part 25 comes into increased contact with the stop surfaces 162. The weight of the carrying arm 2 and any load hanging thereon—by virtue of resting on the underside of the plug-in opening 11 so as to be capable of pivoting to a limited extent—results in the plug-in part 25 being pushed to an increased extent in the direction of the ceiling 13 of the plug-in sleeve 1 and thus in the locked state being secured to a relatively pronounced extent, the action of the carrying arm 2 being pulled out of the plug-in sleeve 1 being blocked.

Removal of the Carrying Arm from the Plug-In Sleeve

The removal of the carrying arm 2 with the plug-in part 25 engaged in the plug-in sleeve 1 takes place in a reversible manner with a return from the third positioning phase into the second positioning phase, as a result of which the plug-in part 25 ends up the unlocked state again, from which the plug-in part 25 with the carrying arm 2 can be pulled out of the plug-in sleeve 1.

FIGS. 9A to 9D

The second variant of the plug-in sleeve 1, in turn, comprises the housing 12 and the frame 10 placed in front of it, the frame enclosing the front, window-like plug-in opening 11, which terminates as a rear plug-in opening 11′. Likewise present are the ceiling 13, the guide contours 14, the base section 15 and the arresting contours 17 on both sides—each with a buffer edge 18 and inlet 19. As a modification to the first variant, instead of the previously centrally arranged ledge 16 with the through-opening 160 and screw seat 161, in this case a respective ledge 16 with through-opening 160 and screw seat 161 is provided on the inside adjacent to the two side flanks of the housing 12. This results in a rear plug-in opening 11′ in the center of the housing. Arranged in front of the two screw seats 161, as seen in the direction of the frame 10, is a respective passage 163 which is in the form of a half-shell and of which the elevation toward the frame 10, directed from the ceiling 13 into the interior of the housing 12, contains the stop surface 162. The two through-openings 160, screw seats 161, stop surfaces 162 and passages 163 are located on parallel lines which cross over the connection between the front and rear plug-in openings 11,11′ at right angles. A hole 141 is located in the ceiling 13, in the region of the connecting line between the two stop surfaces 162. A head 390 of a screw 39 is positioned in each of the screw seats 161, the threaded shank 391 of this screw projecting through the associated through-opening 160. A nose 142 is located on the outside of the ceiling 13, at the transition to the frame 10, in a central position on the housing 12. The plug-in sleeve 1 is advantageously produced as a single-piece casting. On the inner sides, which are directed toward the rear plug-in opening 11′, each ledge 16 has a blind groove 166 which is open in the upward direction.

FIGS. 10A to 10D

The second variant of the sleeve holder 3 likewise has a housing 30 of complementary form for accommodating the plug-in sleeve 1, the extensions 31 in this case, rather than being attached laterally in a wing-like manner to the housing 30, being provided as a flange which is located in a vertical plane and has a relatively long downward part 35 and an upward part 35′. The downward and upward parts 35,35′ are attached to the housing 30 at the top and bottom and divide it up into the relatively long rear portion 301 and the shorter front portion 300. The down-ward and upward parts 35,35′ contain first and second screw holes 310,311. A leveling marking 312 is provided on the front surface of the downward part 35, in a central position beneath the front portion 300. The front portion 300 terminates at the front with the front surface 302, which has a respective marking protuberance 303 extending from each of its corners and which encases the plug-in opening 32. In the top longitudinal strip, a knot 304 is introduced into the front surface 302. The rear plug-in opening 32′ opens out at the free end of the rear portion 301, the two plug-in openings 32,32′ being open all the way through in relation to one another. For stiffening purposes, ribs 36 and a transverse rib 36′ are provided on the rear side of the upward and downward parts 35,35′, and extend onto the housing 30. To complement the outer ledges 16 with the through-openings 160 on the plug-in sleeve 1, the sleeve holder 3 has a crosspiece 33 at the free end of the rear portion 301, to the sides of the rear plug-in opening 32′ in each case, a screw hole 34 with internal thread extending through the crosspiece.

FIGS. 11A and 11B

This pair of figures illustrates the second variant of a plug-in sleeve 1 interacting with the first variant of a plug-in part 25 of a carrying arm 2. As has already been explained in relation to FIGS. 3A and 3B, the plug-in part 25 is intended for pushing into the plug-in sleeve 1 with arresting action and has, at the front, the end 27, in the front corner regions, the outer claws 28 and, on the side flanks, the cut-out mating contours 26. Opposite the end 27, the plug-in end 22 of the rod part 20 of the carrying arm 2 is connected to the plug-in part 25. Prior to the plug-in part 25 being introduced into the front plug-in opening 11, the two are aligned with one another (see FIG. 11A). For continuation of assembly, the heads 390 of the screws 39 are located in the screw seats 161, and the threaded shanks 391 project out of the through-openings 160. Prior to a carrying arm 2 being moved up into close proximity, the front plug-in opening 11 and the passages 163 provide access for a screwing tool, in order to screw the screws 39 into the screw holes 34 of the sleeve holder 3.

In the fully pushed-in and arrested state, the arresting contours 17 end up located within the mating contours 26, the end 27 resting against the stop surfaces 162 and the outer claws 28 enclosing the front buffer edges 18 of the arresting contours 17. Depending on its length, the inlet 19 of the respective arresting contour 17 will project beyond the mating contours 26 or end up located therein (see FIG. 11B). Bevels or rounded portions on the outer claws 28, the mating contours 26 and the buffer edges 18 facilitate the introduction of the plug-in part 25 and prevent injury during handling, as a result of sharp edges being avoided.

FIGS. 12A to 12D

In the first application, provision is made for the sleeve holder 3 to be fastened, by way of its flange-like extension 31, on the rear side 41 of a panel element 4. This is done by means of screws 38 which engage, by way of their threaded shank 381, through screw holes 310,311 in the extension 31 into screw holes 43 in the panel element 4, the screw heads 380 being positioned on the rear side of the extension 31. In the assembled state, the front portion 300 of the housing 30 projects into the through-passage 42 without projecting on the front side 40 of the panel element 4. The plug-in sleeve 1 has its housing 12 pushed through the plug-in opening 32, into the housing 30 of the sleeve holder 3, to the maximum extent, so that the frame 10 rests on the front side 40 of the panel element 4 and the nose 142 of the plug-in sleeve 1 moves into the notch 304 on the sleeve holder 3. For fastening the plug-in sleeve 1, the screws 39 are screwed into the screw holes 34 by way of their threaded shanks 391. The rear portion 301 of the sleeve holder 3 extends horizontally from the rear side 41 of the panel element 4.

In the case of the non-electrified embodiment here the blind grooves 166, the hole 141 and the rear plug-in opening 11′ on the plug-in sleeve 1 and the rear plug-in opening 32′ on the sleeve holder 3 remain unoccupied. The front plug-in opening 11, which is directed into space, is ready for accommodating a plug-in part 25 with adjoining carrying arm 2.

FIGS. 13A, 13B and 18A

These Figures show the second variant of the sleeve holder 3 in its third application, inserted into a vertical support 6. Corresponding to the dimensions of the cross section of the housing 30 and of the ribs 36 and transverse ribs 36′, an aperture is provided in the first outer surface 61 of the vertical support 6, so that, of the sleeve holder 3 which is mounted thereon, the rear portion 301 projects into the interior of the vertical support 6 and the flange-like extension 31 is positioned, by way of its rear side, on the outer surface 61. The extension 31 is fastened on the vertical support 6 by means of screws 319 which grip through the screw holes 310. From the extension 31, the front portion 300 of the housing 3 projects, in the first instance, into space, it being the case, in the completed construction, that a panel element 4 with a through-passage 42 is positioned in front of the vertical support 6 and the front portion 300 projects into the same. The housing 12 of the plug-in sleeve 1 is pushed into the front plug-in opening 32 of the sleeve holder 3 until the frame 10 is positioned on the front side 40 of the panel element 4. The plug-in sleeve 1 pushed into the sleeve holder 3 is secured, in turn, by means of screws 39, as has been described above. The front plug-in opening 11, in turn, is ready for accommodating a plug-in part 25.

The vertical support 6 is a hollow quadrilateral profile with the front surface 61, the adjacent side surfaces 62,64 and the outer surface 63, which is located between the side surfaces. The vertical support 6 is retained on a building wall, for example, by means of a fastening strut 60, which is fixed to the side surface 62 by screws 69.

FIGS. 14A to 14C

This series of figures shows the functional principle of the device, which, in the respective second variant of the plug-in sleeve 1 and of the sleeve holder 3 in combination with the first variant of the plug-in part 25, is not electrified, in the three characteristic positioning phases, many points in the handling sequence here corresponding to the handling sequence for a device with the first variants of all the components 1,3,25, as has been described in relation to FIGS. 8A to 8C. The first positioning phase (see FIG. 14A), in turn, illustrates a carrying arm 2 with the plug-in part 25, which terminates at the front with the end 27, being moved up into close proximity in an inclined position. In the second positioning phase (see FIG. 14B), the plug-in part 25 is located on the stop surfaces 162 by way of the lowered end 27 of the now inclined carrying arm 2, the wedge-shaped arresting contours 17 still being located outside the mating contours 26. In the third positioning phase (see FIG. 14C), the carrying arm 2 has been moved into the horizontal, so that the arresting contours 17 are then enclosed by the mating contours 26 and the carrying arm 2 is thus secured, with arresting action, against being pulled out.

FIGS. 15A to 15D and 17

The rest of the figures up to the final figure, FIG. 22C, inclusive illustrate the device with, in each case, the second variant of the plug-in sleeve 1, the sleeve holder 3 and the plug-in part 25 provided with electrification. In anticipation of the assembly sequence, the positioning of the first coupling part 7 in the plug-in sleeve 1 is described in this sequence of figures. A cable K is routed up to the first coupling part 7 from the rear, while the contacts 73, which are electrically screened in the manner of a conventional plug connector, are accessible from the front. On the sides, the first coupling part 7 has a respective journal 70 with an axial hole 71, the two journals 70 being aligned with one another. A hole 72 extends through the first coupling part 7 from above.

With the insertion of the first coupling part 7 into the plug-in sleeve 1, the coupling part 7 is positioned basically vertically, so that the journals 70 can be moved into the blind grooves 166. Once the coupling part 7 has then been rotated through approximately 90°, it ends up located horizontally in the plug-in sleeve 1, in which case the fed cable K projects out of the rear plug-in opening 11′ and the contacts 73 are accessible from the vanishing line of the front plug-in opening 11. In order to secure the coupling part 7, which can be moved to a limited extent about the journals 70, the second clamp part 96 has been plugged on, this clamp part engaging into the hole 141 in the housing 12 by way of its pin 97 and into the hole 72 on the coupling part 7 by way of its pin 98.

The second clamp part 96 forms the clamp 9 together with the first clamp part 91, which is initially interconnected, it being possible for the clamp parts 91,96 to be separated from one another by being broken or cut along a line 90. The first clamp part 91 has, in its central region, two grooves 92 which are open in the downward direction and are intended for the through-passage of two cores of the cable K. The clamp 9 is preferably produced as a plastic injection molding.

FIG. 16

This figure shows the plug-in sleeve 1, with the first coupling part 7 inserted, in close proximity to a sleeve holder 3, in order for the plug-in sleeve 1 to be introduced into the latter and fastened there. The cable K extending from the coupling part 7 is introduced into the sleeve holder 3, through the front plug-in opening 32 of the latter, and passes out again at the rear plug-in opening 32′, in order to be connected to the power supply. Once the plug-in sleeve 1 has been pushed into the sleeve holder 3, with the cable K being pushed back simultaneously, the plug-in sleeve 1 is fixed in the sleeve holder 3 by means of the screws 39.

FIGS. 18A to 18E

The sequence of FIGS. 18A, 18C and 18D illustrates the assembly of the plug-in sleeve 1 with the first coupling part 7 in combination with the third application of the sleeve holder 3. The cable K, which is fed through the rear plug-in opening 32′, has been connected to the first coupling part 7, it being the case, in the first instance, that the cable K and the coupling part 7, with the clamp 9 plugged on, are restrained in the sleeve holder 3 in order to prevent any slipping out through the rear plug-in opening 32′. In this securing position, the first clamp part 91 rests against the crosspieces 33 from the inside, the cable cores run through the grooves 92, the coupling part 7 is seated in front of the clamp part 91, and the pin 98 of the second clamp part 96 engages laterally in the hole 71 of a journal 70. Prior to the coupling part 7 being inserted into the plug-in sleeve 1, the coupling part 7, with the clamp 9, is pulled out through the front plug-in opening 32 (see

FIG. 18A).

In the next assembly step, the clamp 9 is removed from the cable K, and the first clamp part 91 is detached and can be disposed of. Thereafter, the coupling part 7 is fitted into the blind grooves 166 by way of its journals 70 (see FIG. 18C) and the first coupling part 7 is secured on the plug-in sleeve 1 by the second clamp part 96, whereupon the plug-in sleeve 1 can be pushed into the sleeve holder 3 (see FIG. 18D).

The series of FIGS. 18B and 18E illustrates the assembly of the plug-in sleeve 1 with the first coupling part 7 in combination with the first application of the sleeve holder 3, i.e. in combination with the latter being fastened, by way of the extension 31, on the rear side 41 of a panel element 4. Provided in the panel element 4, to complement the vertical cross section of the front portion 300 of the housing 30, is the through-passage 42 in which, in the assembled state, the front portion 300 ends up located and through which the plug-in sleeve 1, provided with the coupling part 7, is pushed into the sleeve holder 3 from the front side 40. Irrespective of the thickness of the panel element 4, the front portion 300 should not project beyond the front side 40. The rear portion 301 of the sleeve holder 3 projects from the rear side 41. With the device in the assembled state, the cable K projects out of the rear plug-in opening 32′ and extends further to the power supply.

FIGS. 19A and 19B

Taking the electrification into account, the second variant of the plug-in part 25 is provided with a second coupling part 8, this plug-in part being adjoined by a shelf 2′ rather than a carrying arm 2, as has been the case up until now. From the end 27 the plug-in part 25 contains an aperture 250 which continues axially as a narrowed channel 251, as a result of which the plug-in part 25 is basically subdivided into two legs which are located in a mirror-inverted manner in relation to one another. As before, the plug-in part 25 has the two outer claws 28 and the following mating contours 26. From the aperture 250, a blind groove 256 extends into each leg, the blind groove not being continuous from top to bottom, so that the journals 80 of the coupling part 8 can be fitted therein in an analogous manner to the way in which the journals 70 of the coupling part 7 are fitted into the blind grooves 166 on the plug-in sleeve 1. The electrically screened contacts 83 of the coupling part 8 are accessible from the front, while a line (not illustrated) extends from the rear of the coupling part 8 and makes its way through the channel 251, e.g. to a lamp.

FIGS. 20A to 20C

This series of figures illustrates the interengagement of the two coupling parts 7, 8 when the plug-in part 25 is pushed into the plug-in sleeve 1. In the state in which the plug-in part 25—with the adjoining shelf 2′—is in close proximity to the plug-in sleeve 1, the coupling parts 7, 8 are at a distance apart from one another, but the contacts 73,83 on both sides are already aligned with one another (see FIG. 20A). The journal 97 of the second clamp part 96 and the pin 98 thereof plug into the housing hole 140 and the journal hole 72 and thus secure the inserted first coupling part 7 in the plug-in sleeve 1.

As the plug-in part 25 is increasingly pushed into the plug-in sleeve 1, the contacts 73,83 on both sides approach one another and the mating contours 26 move gradually onto the upwardly sloping arresting contours 17 (see FIG. 20C).

When the plug-in part 25 has been pushed all the way into the plug-in sleeve 1—the end 27 of the plug-in part butting against the stop surfaces 162—the contacts 73, 83 move all the way into one another, even when the end 27 of the now inclined shelf 2′ is still in the lowered position, and make the electrical connection. As the shelf 2′ is oriented horizontally, the arresting contours 17 pass into the mating contours 26 and the two coupling parts 7,8 are aligned with one another (see FIG. 20B).

FIGS. 21A and 21B

This pair of figures shows, in the electrified embodiment—as a supplement to the construction according to FIGS. 12A to 12D—a sleeve holder 3 in the first application, fastened on the rear side 41 of the panel element 4, with the plug-in sleeve 1 accommodated from the front side 40 of the panel and the plug-in part 25, which is adjoined by a shelf 2′, pushed therein. The plug-in sleeve 1 is provided with a first coupling part 7, which is fed power via the cable K. The associated plug-in part 25 may be designed in accordance with the second variant of FIG. 19B and be provided with a second coupling part 8. If it is desired to dispense with the connection of an electrical consuming unit, the second coupling part 8 is done away with or the first variant of a plug-in part 25 according to FIG. 3A could be used.

FIGS. 22A to 22C

This series of figures illustrates the functional principle of the device, which, in the respective second variant of the plug-in sleeve 1 and of the sleeve holder 3 in combination with the second variant of the plug-in part 25, is now electrified, in the three characteristic positioning phases. Many points in the handling sequence here correspond to the handling sequence for a device with the first variants of all the components 1,3,25—as has been described in relation to FIGS. 8A to 8C—and also with the second variants of all the components 1,3,25 without electrify-cation, as per the description relating to FIGS. 14A to 14C.

The first positioning phase (see FIG. 22A) thus shows, once again, a carrying arm 2 with the plug-in part 25, which terminates at the front with the end 27, but now has the second coupling part 8 projecting beyond it toward the front, being moved up into close proximity in an inclined position. The first coupling part 7, which is seated in a plug-in sleeve 1, is at a distance apart from the second coupling part 8, so that there is no initial mechanical engagement, nor is any electrical contact made. In the second positioning phase (see FIG. 22B), the plug-in part 25 is located on the stop surfaces 162 by way of the lowered end 27 (not visible here) of the now inclined carrying arm 2, and the wedge-shaped arresting contours 17 are still located outside, and above, the mating contours 26. The coupling parts 7,8 here have been pushed mechanically one inside the other to the maximum extent and are in electrical contact with one another. In the third positioning phase (see FIG. 22C), the carrying arm 2 has been moved into the horizontal, as a result of which the mating contours 26 move onto the arresting contours 17 and enclose the latter. At the same time, the two coupling parts 7,8 are aligned with one another. The carrying arm 2 is now secured against being pulled out.

1. A device for suspending articles or for securing a bearing means, with:
a) a plug-in sleeve (1), the latter:
aa) having a front plug-in opening (11) which continues axially as a free space into the interior of the plug-in sleeve (1);
ab) having an arresting contour (17) on its inside; and
ac) being intended for fastening directly or indirectly on a carrying structure (4,5,6);
b) a load carrier (2,2′), the latter:
ba) having a plug-in part (25) intended for introducing into the front plug-in opening (11);
bb) the plug-in part (25) having a mating contour (26), which is provided for engaging with the arresting contour (17) on the plug-in sleeve (1); and
bc) serving for suspending articles directly or for supporting a bearing means;
c) the configuration of plug-in part (25) and plug-in sleeve (1) forcing the introduction of the plug-in part (25) into the plug-in sleeve (1) with the load carrier (2, 2′) inclined in relation to the horizontal overall, the plug-in part (25) being in a lowered position; and
d) the engagement between the arresting contour (17) and the mating contour (26), as the locked state, being achieved once the load carrier (2, 2′) moves as a whole into the horizontal with the plug-in part (25) located horizontally, characterized in that
e) the arresting contour (17) is formed on the underside of the ceiling (13) and/or on the side flanks of the housing (12) of the plug-in sleeve (1);
f) the mating contour (26) is provided on the top side of the plug-in part (25) and/or on the side flanks thereof; and
g) the arresting contour (17) is designed as an elevation and the mating contour (26) is designed as a recess.

2. The device as claimed in claim 1, characterized in that
a) the arresting contour (17) is arranged on both sides of the ceiling (13) of the housing (12) of the plug-in sleeve (1), at the transition to the side flanks of the latter; and
b) the mating contour (26) is located in the two side flanks of the plug-in part (25).

3. The device as claimed in at least one of claims 1 and 2, characterized in that
a) the arresting contour (17) on both sides extends essentially from the ceiling (13) and is directly adjacent to the side flanks of the housing (12) of the plug-in sleeve (1); and
b) the mating contour (26) is provided in the two side flanks of the plug-in part (25) in each case as a recess which passes vertically all the way through and is set back in relation to the end (27), as a result of which an outer claw (28) is produced in each case in the front corner regions of the plug-in part (25).

4. The device as claimed in at least one of claims 1 to 3, characterized in that the arresting contour (17) on both sides
a) begins, in the direction of the front plug-in opening (11), with an inlet (19) located on the same plane as the ceiling (13);
b) slopes up in a wedge-shaped manner in the opposite direction;
c) terminates, toward the rear part of the housing (12) of the plug-in sleeve (1), with a buffer edge (18); and
d) in the locked state, the two outer claws (28) grip behind the associated buffer edge (18) in each case.

5. The device as claimed in at least one of claims 1 to 4, characterized in that
a) the plug-in opening (11) is of rectangular cross section and has a frame (10) positioned around it in a flange-like manner;
b) the plug-in part (25), at least to the extent where it is guided through the front plug-in opening (11), likewise has a rectangular cross section and is preferably made of metal;
c) at least one stop surface (162), which limits the maximum push-in depth of the plug-in part (25), is provided inside the housing (12) of the plug-in sleeve (1), in the rear region, which is located opposite to the front plug-in opening (11);
d) inside the housing (12) of the plug-in sleeve (1) is at least one screw seat (161) with a through-opening (160) for the introduction of a fastening screw (39) for fixing the plug-in sleeve (1); and
e) the plug-in sleeve (1) is preferably a single-piece metal casting or plastic injection molding.

6. The device as claimed in at least one of claims 1 to 5, characterized in that
a) at the rear end, which is located opposite the frame (10), the plug-in sleeve (1) has a rear plug-in opening (11′) and retaining contours (166) for the insertion of a first electrical coupling part (7) with a cable (K) routed up into place; and
b) the plug-in part (25) has an aperture (250) and retaining contours (256) for the insertion of a second electrical coupling part (8), with a continuing cable (K) for supplying power to a consuming unit, the two coupling parts (7,8), with the plug-in part (25) pushed into the plug-in sleeve (1) to the maximum extent, being intended for engaging mechanically and electrically with one another.

7. The device as claimed in at least one of claims 1 to 6, characterized in that
a) a sleeve holder (3) is provided for accommodating the housing (12) of the plug-in sleeve (1), this sleeve holder being intended for fastening on the carrying structure (4,5,6) of the plug-in sleeve and having:
b) a housing (30), which is divided up into a front portion (300) and a rear portion (301);
c) a front plug-in opening (32), which is accessible from the front portion (300), and a rear plug-in opening (32′), which is accessible from the rear portion (301);
d) flange-like extensions (31), which grip the housing (30) at the transition between the front portion (300) and rear portion (301); and
e) at least one crosspiece (33), which is provided at the free end of the rear portion (301) and has a screw hole (34) for the engagement of the threaded shank (391) of the at least one fastening screw (39), which fixes the plug-in sleeve (1) and has its head (390) positioned in the screw seat (161).

8. The device as claimed in at least one of claims 1 to 7, characterized in that
a) the plug-in sleeve (1) is intended for plugging through a through-passage (42) in the panel element (4);
b) the frame (10) of the plug-in sleeve (1), this frame enclosing the front plug-in opening (11), is positioned on the front side (40) of the panel element (4);
c) the inserted plug-in sleeve (1) is fixed by a sleeve holder (3), which accommodates the rear part of the plug-in sleeve (1); and
d) the extensions (31) of the sleeve holder (3) are provided with the screw holes (310,311) therein for screwing on the rear side (41) of the panel element (4) or on a carrying structure (5) erected behind the panel element (4); in which case
e) the front portion (300) of the sleeve holder (3) can project into the through-passage (42) in the panel element (4).

9. The device as claimed in at least one of claims 1 to 7, characterized in that
a) the extensions (31) of the sleeve holder (3), with the screw holes (310,311) therein, can be utilized for screwing on an outer surface (61) which is directed into space and belongs to a vertical support (6) in the form of a hollow polygonal profile, this vertical support serving as a carrying structure (6);
b) the rear portion (301) of the sleeve holder (3) projects into the cavity of the vertical support (6);
c) the front portion (300) of the sleeve holder (3) projects into the through-passage (42) in the panel element (4); and
d) the frame (10) of the plug-in sleeve (1), this frame enclosing the front plug-in opening (11), is positioned on the front side (40) of the panel element (4).

10. The device as claimed in at least one of claims 1 to 9, characterized in that the rod part (20) of the carrying arm (2)
a) is a round or quadrilateral tube which is rectilinear or curved or is angled one or more times; or
b) is a round or quadrilateral bar which is rectilinear or curved or is angled one or more times; or
c) bears a shelf (2′) which is supported by at least one retaining element, e.g. a transverse strut, at the front end (21) and/or at the plug-in end (22); or
d) merges into a transverse rod at the front end (21) and may additionally be provided with a shelf (2′).
